(19) United States
(12) Patent Application Publication
(10) Pub. No.: US 2021/0307415 A1
(43) Pub. Date: Oct. 7, 2021

(54) PROTECTIVE FACE MASK

(71) Applicant: Savage Brands, Inc. (DBA Savage Shield), Irvine, CA (US)

(72) Inventor: Joseph Frank Scalisi, Yorba Linda, CA (US)

(21) Appl. No.: 17/039,240

(22) Filed: Sep. 30, 2020

Related U.S. Application Data
(63) Continuation-in-part of application No. 16/914,199, filed on Jun. 26, 2020.
Application No. 16/914,199 is a continuation-in-part of application No. 16/846,273, filed on Apr. 10, 2020.
(60) Provisional application No. 63/024,882, filed on May 14, 2020.
(60) Provisional application No. 63/005,302, filed on Apr. 4, 2020.

(51) Int. Cl. A41D 13/11; A62B 23/02

(52) U.S. Cl. CPC A41D 13/1138; A41D 13/1161; A62B 23/025

(57) ABSTRACT

A protective face mask may comprise an outer housing including a first plurality of ventilation holes, and an inner housing detachably coupled to the outer housing, the inner housing configured to cover a nose and a mouth of a user, the inner housing including a second plurality of ventilation holes. The protective face mask may also include a replaceable filter configured to be received in a space between the inner housing and the outer housing. In some embodiments, the protective face mask includes a sensor unit coupled to at least one of the inner housing and the outer housing, the sensor unit configured to detect a presence of a contaminant on the replaceable filter.

### CROSS-REFERENCE TO RELATED APPLICATIONS

This application is a continuation-in-part of U.S. Nonprovisonal patent application Ser. No. 16/846,273; filed Apr. 10, 2020; entitled PROTECTIVE FACE MASK; and having attorney docket number SCALISI.010A.

This application claims the benefit of U.S. Provisional Patent Application No. 63/005,302; filed Apr. 4, 2020; entitled FACE MASK; and having an attorney docket number SCALISI.010P.

### BACKGROUND

### Field

Various embodiments disclosed herein relate to protective face masks. Certain embodiments relate to protective face masks including a dual breathing chamber.

### Description of Related Art

Protective face masks can prevent the spread of illness by providing a barrier between the external environment and a mouth and nose of a user. Protective face masks may also filter the air breathed by the user. Protective face masks often cover the lower portion of the user's face and are secured with a strap(s) and/or tie(s). The strap(s) and/or tie(s) may go around a user's head, or may secure around the user's ears. Protective face masks may be worn by healthcare workers, anyone working in an environment with large amounts of particulate matter in the air (e.g., firefighters, construction workers, etc.), and anyone in the general public who desires protection from pollution and/or illness.

### SUMMARY

The disclosure includes a protective face mask, and in some embodiments, the protective face mask includes an outer housing including a plurality of ventilation holes, and an inner housing detachably coupled to the outer housing, the inner housing configured to cover a nose and a mouth of a user, the inner housing including a second plurality of ventilation holes, wherein a space between the inner housing and the outer housing is configured to receive a replaceable filter. The inner housing may comprise a partition configured to divide the inner housing into an upper chamber and a lower chamber.

In some embodiments, when the mask is coupled to a face of the user, the partition is configured to be located below the nose of the user and above the mouth of the user. The partition may comprise a silicone overmold. In some embodiments, the silicone overmold is further configured to form a seal against a face of the user. The upper chamber may be configured to receive the nose of the user and the lower chamber may be configured to receive the mouth of the user. In some embodiments, the division of the inner housing into the upper chamber and the lower chamber is configured to reduce moisture collection on the replaceable filter.

The outer housing may be configured to receive the inner housing via a friction fit. In some embodiments, the outer housing is configured to receive the inner housing via a channel lock. The outer housing may comprise a female portion of the channel lock that extends around an inner perimeter of the outer housing, and the inner housing may comprise a male portion of the channel lock that extends around an outer perimeter of the inner housing.

In some embodiments, the outer housing and the inner housing comprise a material configured to impart at least one of anti-bacterial, anti-viral, and anti-fungal properties to the protective face mask. The material may comprise silver nanoparticles.

In some embodiments, the outer housing comprises a first aperture located along a first side of the outer housing and a second aperture located along a second side of the outer housing located opposite the first side, wherein the first aperture and second aperture are configured to receive a strap. The strap may comprise a material that is configured to stretch and an adjusting mechanism configured to adjust a length of the strap. In some embodiments, the material includes silver nanoparticles.

The replaceable filter may comprise four layers. In some embodiments, the four layers comprise a first sealed filter, a flux filter, a carbon filter, and a second sealed filter.

The outer housing may define a first width and the inner housing may define a second width, wherein the first width is larger than the second width.

In some embodiments, each hole in the first plurality of ventilation holes defines a first area and each hole in the second plurality of ventilation holes defines a second area, wherein the second area is larger than the first area. Each hole in the first plurality of ventilation holes may define a shape that is at least one of substantially round and substantially ovoid. Each hole in the second plurality of ventilation holes may define a shape that is substantially hexagonal.

The disclosure includes a protective face mask comprising an outer housing including a first plurality of ventilation holes, an inner housing detachably coupled to the outer housing, the inner housing configured to cover a nose and a mouth of a user, the inner housing including a second plurality of ventilation holes, wherein a space between the inner housing and the outer housing is configured to receive a replaceable filter, and a sensor unit coupled to at least one of the inner housing and the outer housing, the sensor unit configured to detect a presence of a contaminant on the replaceable filter. In some embodiments, the sensor unit is configured to detect whether air flow through the replaceable filter is less than a predetermined air flow restriction level.

The sensor unit may comprise a sensor housing and at least one sensor pad, wherein the sensor housing is at least one of electrically and communicatively coupled to the at least one sensor pad. In some embodiments, the protective face mask further comprises a battery coupled to the sensor unit, a central processing unit coupled to the sensor unit and electrically coupled to the battery, wherein the central processing unit is capable of detecting at least one of the presence of the contaminant on the replaceable filter and whether the air flow through the replaceable filter is less than the predermined air flow restriction level, and a LED coupled to the sensor unit and eletrically coupled to the battery.

In some embodiments, the LED is configured to protrude through the inner housing to an interior portion of the outer housing, such that the LED is visible through an opening on an exterior portion of the outer housing. The LED may be configured to illuminate in response to detecting the presence of the contaminant on the replaceable filter. The LED may be configured to illuminate in response to detecting whether the air flow through the replaceable filter is less than the predetermined air flow restriction level. In some embodiments, the at least one sensor pad is configured to couple to at least one ventilation hole of the second plurality of ventilation holes.

The LED may be configured to emit light in at least one of a plurality of colors and a plurality of patterns. In some embodiments, the LED is configured to emit light in at least one of a first color and a first pattern upon detection of the presence of the contaminant on the replaceable filter, and is configured to emit light in at least one of a second color and a second pattern upon detection of whether air flow through the replaceable filter is less than the predetermined air flow restriction level.

The at least one sensor pad may comprise a first sensor pad and a second sensor pad, wherein the first sensor pad may be configured to detect the presence of the contaminant on the replaceable filter and the second sensor pad may be configured to detect whether air flow through the replaceable filter is less than the predetermined air flow restriction level. In some embodiments, the first sensor pad is located on an exterior surface of the replaceable filter and the second sensor pad is located on an interior surface of the replaceable filter.

The sensor unit may be communicatively coupled to a mobile application on a remote computing device and may be configured to share data about the replaceable filter with the mobile application. The sensor unit may further comprise a transmitter capable of at least one of Bluetooth, WiFi, and cellular communication. In some embodiments, the protective face mask comprises a first protective face mask and the transmitter comprises a first transmitter, further comprising a second protective face mask including a second transmitter capable of at least one of Bluetooth, WiFi, and cellular communication. The first protective face mask may be configured to communicate with the second protective face mask via the first transmitter communicating with the second transmitter via at least one of Bluetooth, WiFi, and cellular communication.

In some embodiments, the first transmitter is configured to share data regarding the replaceable filter with the second transmitter, and the second transmitter is configured to share data regarding a replaceable filter of the second protective face mask with the first transmitter. The protective face mask may further comprise a third party device configured to communicate with at least one of the first transmitter and the second transmitter via at least one of Bluetooth, WiFi, and cellular communication. In some embodiments, the third party device comprises a RFID reader configured to obtain data from at least one of the first transmitter and the second transmitter and determine, from the data, a status of at least one of the first protective face mask and the second protective face mask. The replaceable filter may comprise three layers.

### BRIEF DESCRIPTION OF THE DRAWINGS

These and other features, aspects, and advantages are described below with reference to the drawings, which are intended to illustrate, but not to limit, the invention. In the drawings, like reference characters denote corresponding features consistently throughout similar embodiments.

FIG. 1 illustrates a perspective view of a user wearing a face mask, according to some embodiments.

FIG. 2 illustrates a front perspective view of a face mask, according to some embodiments.

FIG. 3 illustrates a back perspective view of a face mask, according to some embodiments.

FIG. 4 illustrates a front view of a face mask, according to some embodiments.

FIG. 5 illustrates a cross-sectional view of a face mask being worn by a user, according to some embodiments.

FIG. 6 illustrates a back view of a face mask, according to some embodiments.

FIG. 7 illustrates a side view of a face mask, according to some embodiments.

FIGS. 8A and 8B illustrate top and bottom views, respectively, of a face mask, according to some embodiments.

FIGS. 9 and 10 illustrate exploded views of a face mask, according to some embodiments.

FIG. 11 illustrates a perspective view of a face mask with a strap, according to some embodiments.

FIG. 12 illustrates layers of a filter of a face mask, according to some embodiments.

FIG. 13 illustrates the relative widths of an inner housing and an outer housing of a face mask, according to some embodiments.

FIG. 14 illustrates a front view of a face mask, according to some embodiments.

FIG. 15 illustrates a back view of a face mask, according to some embodiments.

FIG. 16 illustrates an exploded view of a face mask including a sensor unit, according to some embodiments.

FIG. 17 illustrates an exploded view of a portion of a sensor unit, according to some embodiments.

FIG. 18 illustrates a perspective view of a portion of a sensor unit, according to some embodiments.

FIG. 19 illustrates a schematic of a sensor unit, according to some embodiments.

FIGS. 20 and 21 illustrate schematic views of a plurality of face masks with additional components, according to some embodiments.

FIGS. 22A, 22B, 23, 24A, and 24B illustrate perspective views of a face mask, according to some embodiments.

### DETAILED DESCRIPTION

Although certain embodiments and examples are disclosed below, inventive subject matter extends beyond the specifically disclosed embodiments to other alternative embodiments and/or uses, and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components.

For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

### COMPONENT INDEX

10—face mask
12—outer housing
14—first plurality of ventilation holes
16—inner housing
18—nose
20—mouth
22—user
24—second plurality of ventilation holes
28—replaceable filter
30—partition
32—upper chamber
34—lower chamber
36—overmold
38—female portion of channel lock
40—male portion of channel lock
42—inner perimeter (of outer housing)
44—outer perimeter (of inner housing)
48—aperture
50—first side
52—second side
54—strap
56—adjusting mechanism
58—layers of filter
58a—first sealed filter
58b—flux filter
58c—carbon filter
58d—second sealed filter
60—first width
62—second width
64—sensor unit
66—sensor housing
68—sensor pad
69—sensor electrical connection
70—battery
71—capacitor
72—central processing unit
73—resistor
74—LED
75—RFID transmitter
76—printed circuit board
77—Bluetooth radio
78—at least one fastening device
79—memory chip
80—breakaway coupling element
86—mobile application
88—remote computing device
90—transmitter
92—third party device
94—RFID reader
96a—sport strap (double strap)
96b—sport strap (single strap)

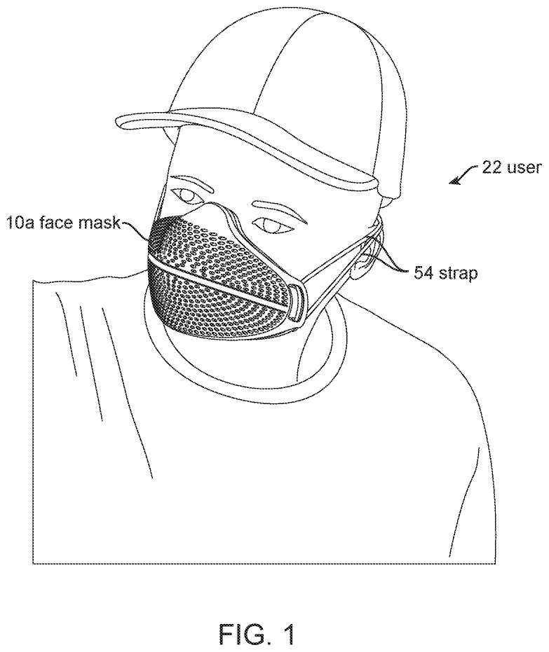

FIG. 1 shows a user 22 wearing a face mask 10a. It should be noted that throughout this disclosure, the terms “face mask”, “mask”, and “protective face mask” may be used interchangeably. The user 22 is shown wearing the face mask 10a such that it covers much of the lower half of the user's face, including the user's nose and mouth. The amount of the user's 22 face covered by the mask 10a may depend on a shape and/or size of the user's 22 face. FIG. 1 also includes a strap 54, which in many embodiments, is used to couple the face mask 10a to the face of the user 22. The strap 54 may be configured to wrap around the head of the user 22, as shown in FIG. 1 and FIG. 11, which will be discussed in greater detail later in the disclosure. In some embodiments, the strap 54 comprises two loop-style straps designed to hook around the ears of the user 22. The strap 54 may be a continuous piece of material or a plurality of individual pieces of material. Additional properties of the strap 54 will be discussed with reference to FIG. 11.

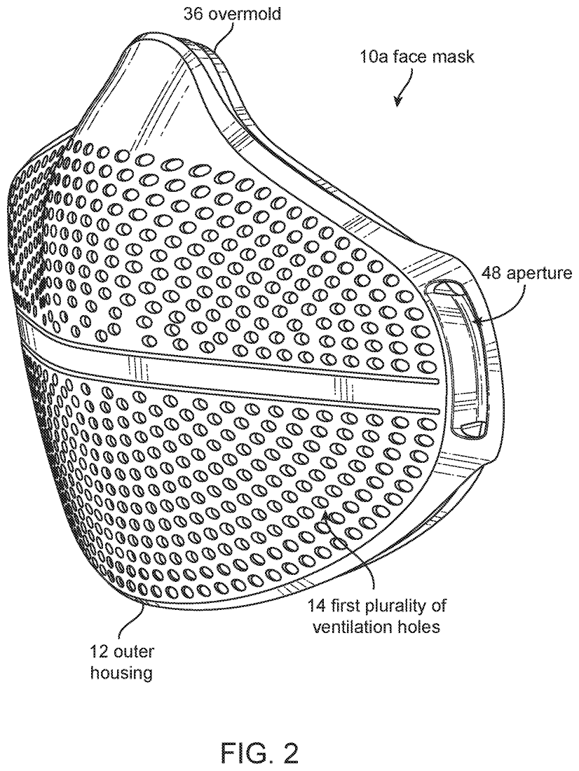

FIG. 2 illustrates a front perspective view of the face mask 10a, according to some embodiments. As shown in FIG. 2, the face mask 10a may include an outer housing 12 and an overmold 36. The overmold 36 may be coupled to the outer housing 12 via an inner housing 16, as will be discussed later in this disclosure. In many embodiments, the outer housing 12 includes a first plurality of ventilation holes 14. As illustrated in FIG. 2, each hole in the first plurality of ventilation holes 14 may be substantially ovoid in shape. In some embodiments, each hole is substantially circular. Each hole in the first plurality of ventilation holes 14 may be any suitable shape. Though FIG. 2 shows the face mask 10a including a solid band with no ventilation holes extending across a center portion of the outer housing 12, in some embodiments, substantially an entire surface of the outer housing 12 includes the first plurality of ventilation holes 14.

FIG. 2 also includes an aperture 48. In many embodiments, the aperture 48 is configured to receive at least part of a strap 54 to thereby enable coupling of the face mask 10a to the face of a user 22. FIG. 2 also shows the face mask 10a including an upper curved portion that extends above the main body of the face mask 10a. In some embodiments, this upper curved portion is configured to cover the nose of the user 22. This feature may provide a comfortable fit and strong seal against the face of the user 22. In some embodiments, the face mask 10a including the upper curved portion is especially designed for use by healthcare workers or others exposed to germs, pollution, and the like at high volumes. The embodiment of the face mask 10a shown in the figures may be considered a “professional protective face mask” and/or a “commercial protective face mask.” In some embodiments, the face mask 10a does not include the upper curved portion, and instead resembles a more symmetrical curved shape, where a top portion of the mask substantially reflects a bottom portion of the mask. The face mask 10a may be sized to fit a child. In some embodiments, a child-size face mask 10a is configured to fit an average-sized child up to about 10 years old.

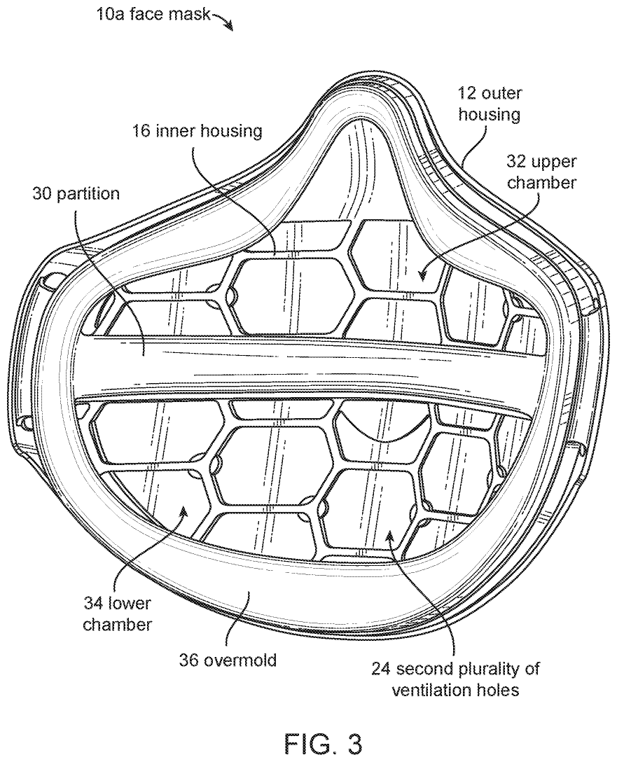

FIG. 3 illustrates a back perspective view of the face mask 10a, according to some embodiments. As shown, the face mask 10a may include the outer housing 12, shown in FIGS. 1 and 2, as well as an inner housing 16. In many embodiments, the face mask 10a also includes an overmold 36, which in turn includes a partition 30 configured to separate the inner housing 16 into a dual breathing chamber comprising two ventilation channels: an upper chamber 32 and a lower chamber 34. The partition 30 may be configured to sit against an area above the upper lip of the user 22 below the nostrils, such that the upper chamber 32 may be configured to receive the nose of a user 22, and the lower chamber 34 may be configured to receive the mouth of the user 22. In many embodiments, separating the nose and mouth of the user 22 reduces moisture collection in the mask, as inhalation and exhalation occur in separate chambers. In addition, most of the moisture collected in the mask may be concentrated to the chamber receiving exhalation (e.g., the lower chamber 34 when the user 22 is exhaling through their mouth). This may enable the inhalation chamber (e.g., the upper chamber 32 when the user 22 inhales through their nose) to remain completely or nearly completely dry.

Using a dual breathing chamber and reducing moisture collection may provide a more comfortable mask-wearing experience for the user 22. In many embodiments of using a traditional face mask, users are forced to re-inhale air that was recently exhaled. In addition to the general discomfort this may cause (e.g., breathing in warm, moist, potentially odorous air), recently exhaled air is higher in carbon dioxide than “fresh” air, and inhaling carbon dioxide in excessive amounts can be harmful to health. As previously stated, the chamber used for inhalation may remain dry, thus enabling the user 22 to inhale fresh, dry air rather than stale and/or damp air. The dual breathing chamber may also provide other benefits, including but not limited to: faster airflow circulation, less obstruction in breathing, reduced “fogging” of glasses worn by the user 22, a general fresh and/or dry feeling on at least a portion of the user's 22 face covered by the mask 10a, and preventing the spread of germs via droplets.

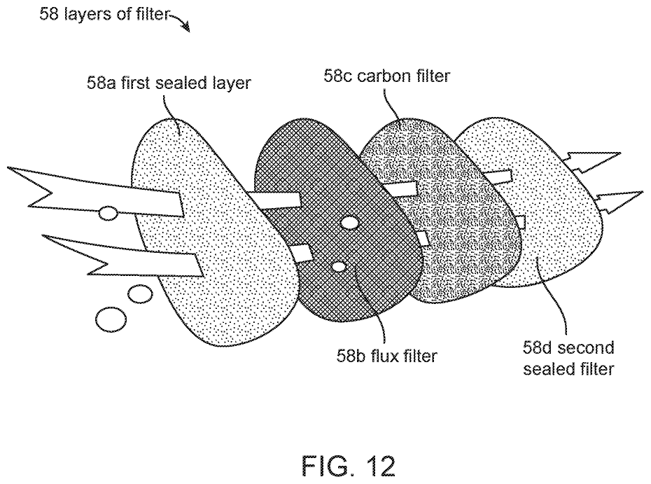

As will be discussed in greater detail with reference to FIG. 12, in some embodiments the face mask 10a includes a replaceable filter. The dual breathing chamber may extend the amount of time that the replaceable filter is effective by reducing the amount of moisture collected on the filter. For example, under heavy use (e.g., in a healthcare setting), the replaceable filter may last about 2 or 3 days. Under everyday use (e.g., a member of the general public wearing a mask for shorter periods of time, such as when running errands), the replaceable filter may last about 5 days.

In many embodiments, the overmold 36 shown in FIG. 3 comprises a piece of silicone overmolded onto the inner housing 16. The silicone may comprise soft fitted silica gel, which may provide a comfortable and flexible fit to the face of the user 22. A flexible fit of the overmold 36 may enable users 22 of varied face shapes and/or sizes to comfortably wear the face mask 10a. In some embodiments, the silicone comprises 8 mm silicone. The overmold 36 may be configured to form a seal on the face of the user 22. In some embodiments, the seal contributes to the longevity of the replaceable filter and general effectiveness of the mask 10a by substantially eliminating the entrance of air—including bacteria, viruses, pollutants, and the like—into the mask 10a through any portion other than the first plurality of ventilation holes 14 on the outer housing 12.

FIG. 3 also illustrates the second plurality of ventilation holes 24. As shown, each hole in the second plurality of ventilation holes 24 may define a substantially hexagonal shape. Each hole may also define a substantially octagonal, pentagonal, heptagonal, rectangular, or any other suitable shape. In some embodiments, and as can be seen when comparing FIG. 2 and FIG. 3, each hole in the second plurality of ventilation holes 24 may define a larger area than each hole in the first plurality of ventilation holes 14.

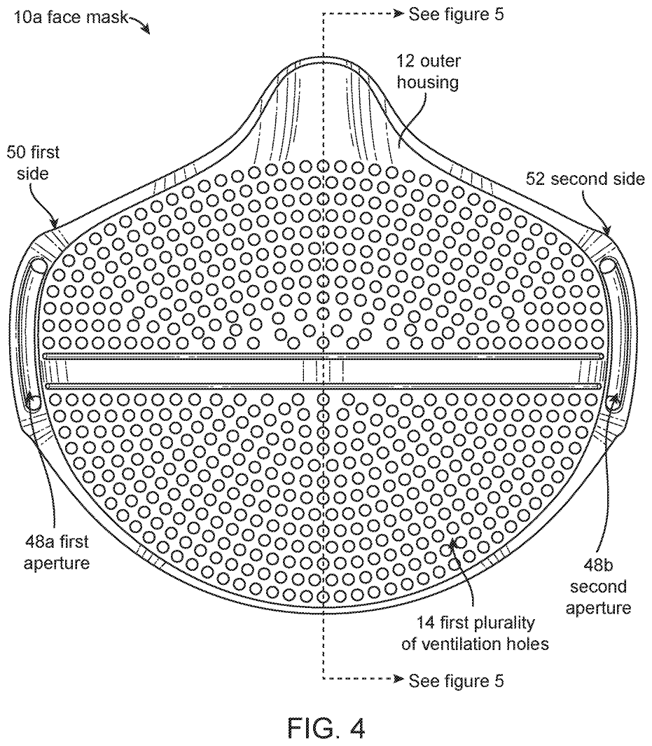

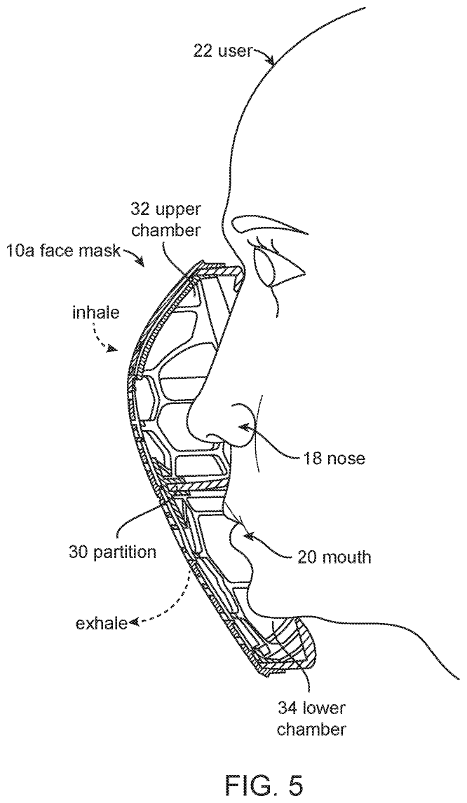

FIG. 4 shows a front view of a face mask 10a, according to some embodiments. Similar to FIG. 2, FIG. 4 includes the outer housing 12 and the first plurality of ventilation holes 14. FIG. 4 expands on the aperture 48 shown in FIG. 2 by including both a first aperture 48a and a second aperture 48b. In some embodiments, the first aperture 48a is coupled to a first side 50 of the outer housing 12, and the second aperture 48b is coupled to a second side 52 of the outer housing 12. As previously discussed, the apertures 48a, 48b may be configured to receive a portion of a strap 54 (not shown) in order to enable coupling the mask 10a to the face of a user 22. In some embodiments, each aperture 48a, 48b is configured to receive individual straps configured to loop around the ears of the user 22. FIG. 4 also includes a dashed line extending down substantially the middle of the face mask 10a with a note to see FIG. 5, indicating a cross-sectional view.

FIG. 5 illustrates the cross-sectional view of the face mask 10a located on a user 22, drawn in profile. FIG. 5 shows that, in some embodiments and as discussed with reference to FIG. 3, the partition 30 is located above the mouth 20 and below the nose 18 of the user 22. The partition 30 thereby separates the face mask 10a into an upper chamber 32, shown receiving the nose 18, and a lower chamber 34, shown receiving the mouth 20. It should be noted that though the user 22 is illustrated in FIG. 5 as inhaling through their nose 18 and exhaling through their mouth 20, the inverse is possible and may be practiced while wearing the face mask 10a. It should also be noted that the face mask 10a may cover less, more, or substantially the same amount of the face of the user 22 illustrated in FIG. 5. As previously mentioned, in many embodiments, the mask 10a is configured to fit comfortably on a variety of face shapes and sizes, so the portion of a user's 22 face covered by the mask 10a may depend on the user's 22 face shape and/or size.

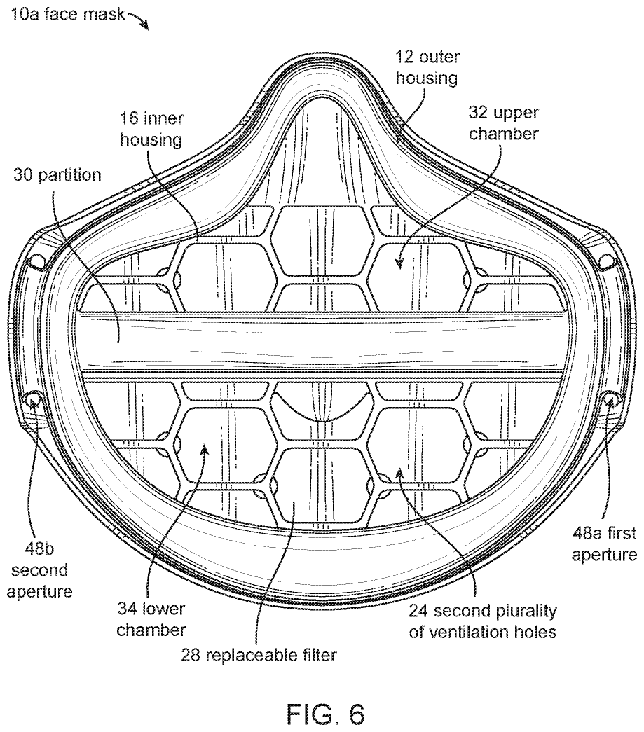

FIG. 6 shows a back view of the face mask 10a, including the outer housing 12, the inner housing 16, and the partition 30. FIG. 6 also illustrates that, in many embodiments, the face mask includes a replaceable filter 28. When the inner housing 16 is coupled to the outer housing 12, the replaceable filter 28 may be located in a space between the inner housing 16 and the outer housing 12. The replaceable filter 28 will be discussed in more detail with reference to FIG. 12. FIG. 6 also includes the first aperture 48a and the second aperture 48b.

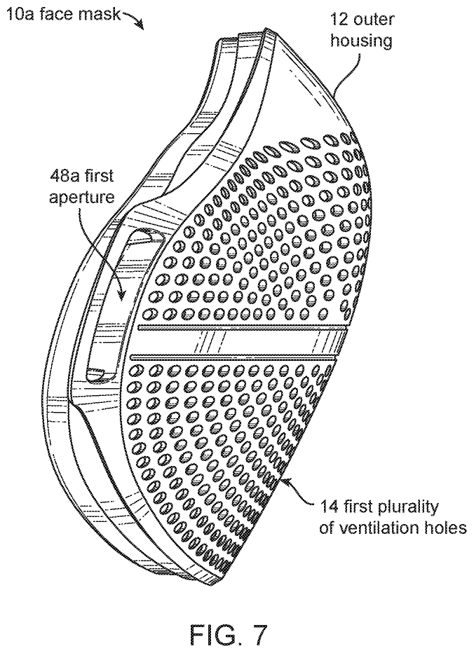

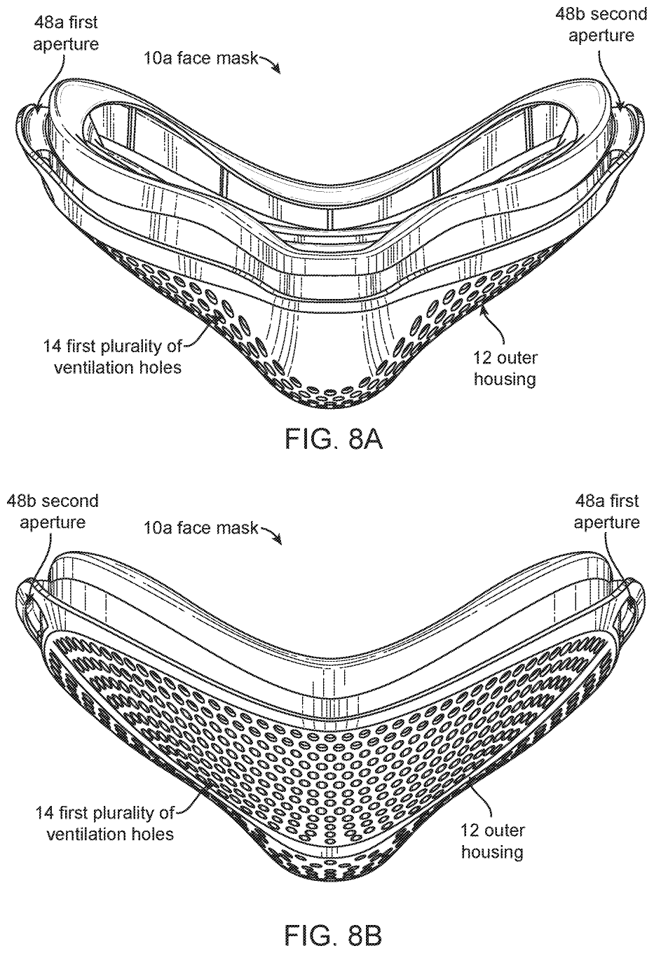

FIG. 7 illustrates a side view of the face mask 10a, according to some embodiments. As shown, the face mask 10a may have a generally curved shape in order to accommodate the nose 18 and mouth 20 of the user 22 that are received within the mask 10a, as shown in FIG. 5. FIG. 7 also shows the first aperture 48a. I should be noted that the first aperture 48a, as well as the second aperture 48b, may comprise a form and/or shape different than what is shown in the Figures. For example, the apertures 48a, 48b may comprise hooks or other such mechanisms designed to retain at least a portion of a strap (or straps) 54. FIGS. 8A and 8B illustrate top and bottom views, respectively, of the face mask 10a, according to some embodiments. As also shown in FIG. 7, FIGS. 8A and 8B illustrate the curved nature of the face mask 10a. Though not labeled, the mask 10a shown in FIGS. 8A and 8B includes the overmold 36. In some embodiments, the face mask 10a does not include the overmold 36.

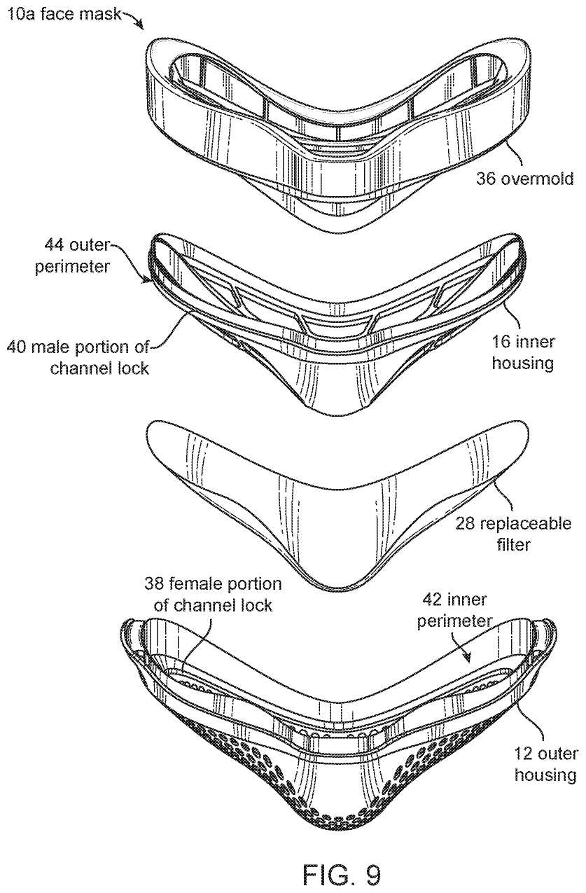

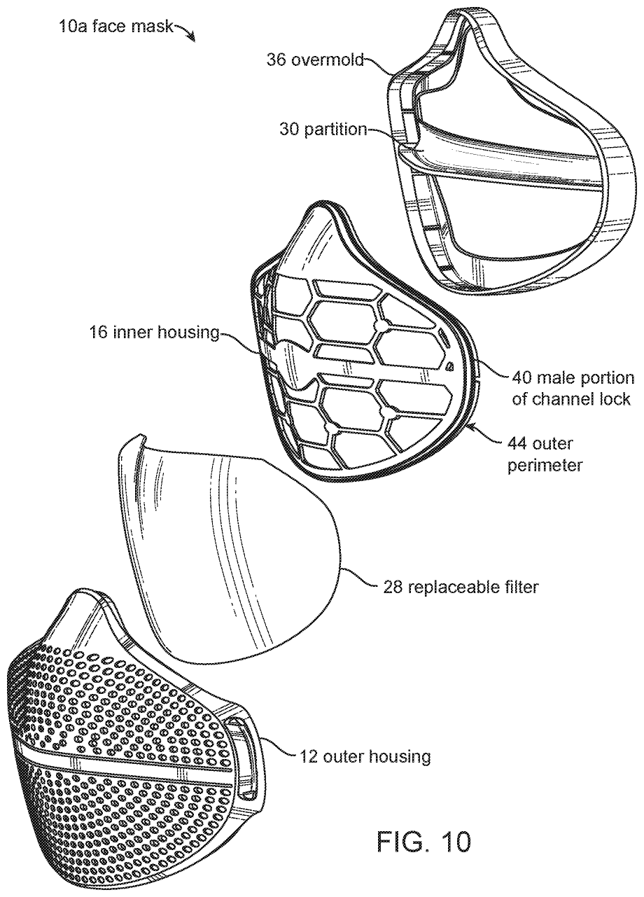

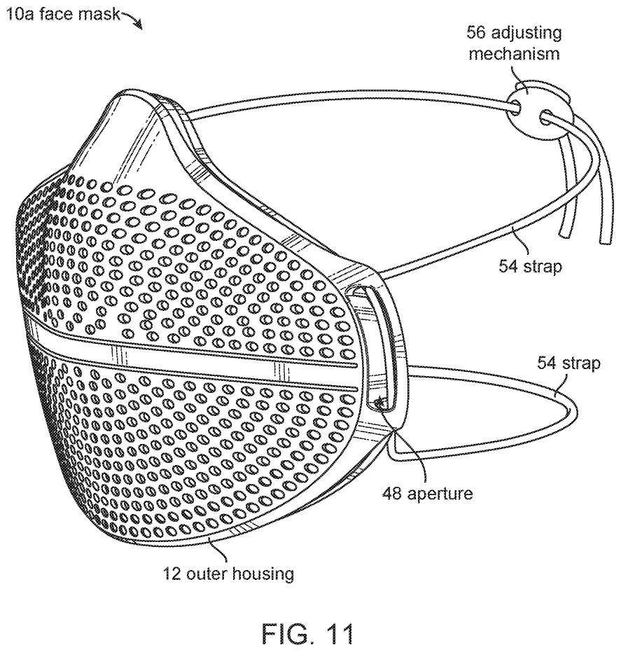

FIGS. 9 and 10 show exploded top and front views, respectively, of the face mask 10a, according to some embodiments. As shown in FIGS. 9 and 10 and as discussed with reference to the other Figures, the face mask 10a may include an overmold 36, an inner housing 16, a replaceable filter 28, and an outer housing 12. As previously discussed, in some embodiments the overmold 36 comprises a soft silicone molded onto the inner housing 16. The overmold 36 may be configured to be molded to an interior portion, including an inner perimeter, of the inner housing 16. Alternatively, the overmold 36 may be configured to be molded to an exterior portion of the inner housing 16.

In many embodiments, the inner housing 16 and the outer housing 12 comprise an at least semi-rigid material, such as plastic. In some embodiments, the plastic is bisphenol A (“BPA”) free for user safety. The housings 12, 16 may comprise polypropylene (“PP”) plastic. In many embodiments, the housings 12, 16 comprise acrylonitrile butadiene styrene (“ABS”) plastic. Whether comprising PP or ABS plastic, or a combination thereof, in some embodiments the material of the housings 12, 16 includes embedded silver nanoparticles. In many embodiments, the integration of silver nanoparticles into the housings 12, 16 imparts at least one of anti-bacterial, anti-viral, and anti-fungal properties to the face mask 10a. In some embodiments, the material composition includes at least 1% silver nanoparticles of the total composition. In some embodiments, the material composition includes less than 1% silver nanoparticles. In some embodiments, the material composition includes less than 0.1% silver nanoparticles. In some embodiments, the material composition includes less than 0.01% silver nanoparticles. In addition, the housings 12, 16 may be able to be washed, such as with warm water and soap, or rinsed, such as with rubbing alcohol, and re-used without breakdown of the housing material. The re-usable nature of the face mask 10a may reduce the amount of waste produced in particular industries, and by the general public, especially when compared to traditional single-use masks. In addition, the face mask 10a may present significantly lower monthly costs than traditional single-use masks.

In some embodiments, the outer housing 12 is configured to detachably receive the inner housing 16 via a friction fit. As previously mentioned, the replaceable filter 28 may be located between the outer housing 12 and the inner housing 16 when the housings are coupled together. In some embodiments, the outer housing 12 is configured to detachably couple to the inner housing 16 via a channel lock. FIG. 9 shows that, according to some embodiments, the inner housing 16 includes a male portion of the channel lock 40 and the outer housing 12 includes a female portion of the channel lock 38. The male portion 40 may be located along an outer perimeter 44 of the inner housing 16, and the female portion 38 may be located along an inner perimeter 42 of the outer housing 12, as illustrated in FIG. 9. As such, the female portion 38 may be configured to receive the male portion 40, thereby detachably coupling the outer perimeter 44 of the inner housing 16 to the inner perimeter 42 of the outer housing 12. FIG. 10 also shows the male portion 40 located along the outer perimeter 44 of the inner housing 16.

FIG. 11 shows another perspective view of the face mask 10a, and includes the strap 54 and an adjusting mechanism 56. As previously discussed, different forms of the strap 54 are possible. FIG. 11 illustrates that, in some embodiments, the strap 54 comprises a continuous strap configured to use at least one aperture 48 to form two loops around the back of the head of a user 22. The adjusting mechanism 56 may be used to adjust the fit of the mask 10a by shortening and/or lengthening the strap 54. In some embodiments, the strap 54 comprises a stretchy material. The material may comprise nylon, elastic, another suitable material, or any combination thereof. Similar to the material comprising the inner and outer housings 12, 16, the strap 54 material may include silver nanoparticles to impart at least one of anti-bacterial, anti-viral, and anti-fungal properties onto the strap 54.

FIG. 12 illustrates the layers 58 of the replaceable filter 28. In some embodiments, and as shown in FIG. 12, the layers 58 include four layers comprising a first sealed filter 58a, a flux filter 58b, a carbon filter 58c, and a second sealed filter 58d. The flux filter 58b may comprise a 2.5 micron filter. As previously mentioned, the replaceable filter 28 may be wearable for about 3 days under heavy use and for about 5 days under light, everyday use. Each layer 58 of the filter 28 may comprise a soft material, and as such, the filter 28 may comprise a soft, flexible combination of materials. In some embodiments, the filter 28 is disposable. By embedding at least one layer 58 with silver nanoparticles, the filter 28 may have similar anti-bacterial, anti-viral, and/or anti-fungal properties as compared to the outer and inner housings 12, 16, and the strap 54. In some embodiments, the filter 28 is available in different sizes. For example, a child-size face mask 10a may require a different size replaceable filter 28 than an adult-size face mask 10a.

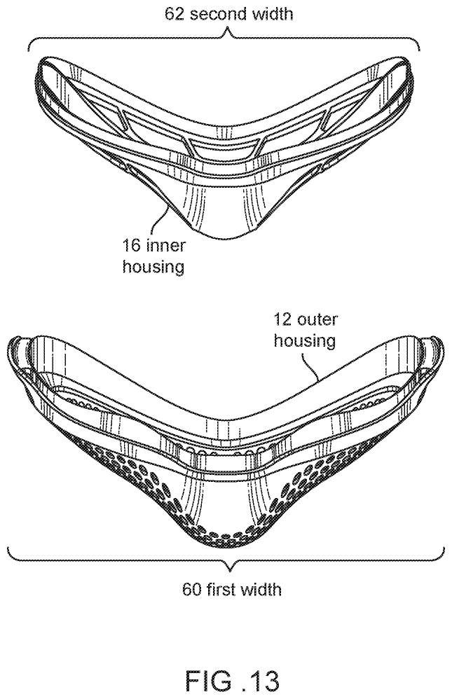

FIG. 13 includes the outer housing 12 and the inner housing 16, and illustrates their respective widths. In some embodiments, a first width 60 of the outer housing 12 is larger than a second width 62 of the inner housing 16. The relative sizes of each of the housings 12, 16 is also shown in FIGS. 9 and 10 and discussed with reference to how the housings 12, 16 detachably couple together; the outer perimeter 44 of the inner housing 16 couples to the inner perimeter 42 of the outer housing 12 via the channel lock.

In some embodiments, the face mask 10a is KN95 certified. The face mask 10a may also be FDA approved and SGS tested. The face mask 10a may also be customizable and available in a variety of colors and/or patterns.

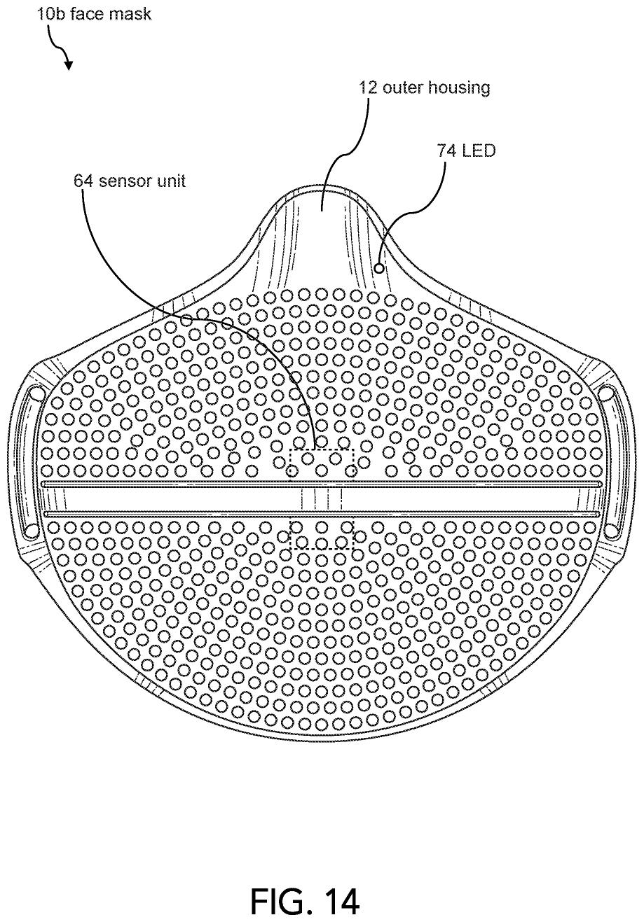

The disclosure includes additional embodiments of the face mask (e.g., face mask 10b, face mask 10c, and face mask 10d), which will be discussed with reference to FIGS. 14-24B. FIG. 14 illustrates a front view of a face mask 10b, according to some embodiments.

Similar to the face mask 10a, the face mask 10b may include an outer housing 12 including a first plurality of ventilation holes 14, an inner housing 16 detachably coupled to the outer housing 12, the inner housing 16 configured to cover a nose 18 and mouth 20 of a user 22, the inner housing 16 including a second plurality of ventilation holes 24, wherein a space between the inner housing 16 and the outer housing 12 is configured to receive a replaceable filter 28, and a sensor unit 64 coupled to at least one of the inner housing 16 and the outer housing 12, the sensor unit 64 configured to detect a presence of a contaminant on the replaceable filter 28.

As shown, in some embodiments, the face mask 10b includes an outer housing 12, a LED 74, and a sensor unit 64. The LED 74 may be visible through an opening in the outer housing 12. In some embodiments, the LED 74 is configured to illuminate in response to the sensor unit 64 detecting a presence of a contaminant on the replaceable filter 28. The LED 74 may also be configured to illuminate in response to the sensor unit 64 detecting whether air flow through the replaceable filter 28 is less than a predetermined air flow restriction level. In some embodiments, the face mask 10b comprises a plurality of LEDs 74, wherein one LED 74 is configured to illuminate in response to the sensor unit 64 detecting the presence of a contaminant and one LED 74 is configured to illuminate in response to the sensor unit 64 detecting an air flow restriction. The at least one LED 74 may be located on any portion of the face mask 10b. In some embodiments, the LED 74 is located on a portion of the face mask 10b that is visible to at least one of the user 22 and another person.

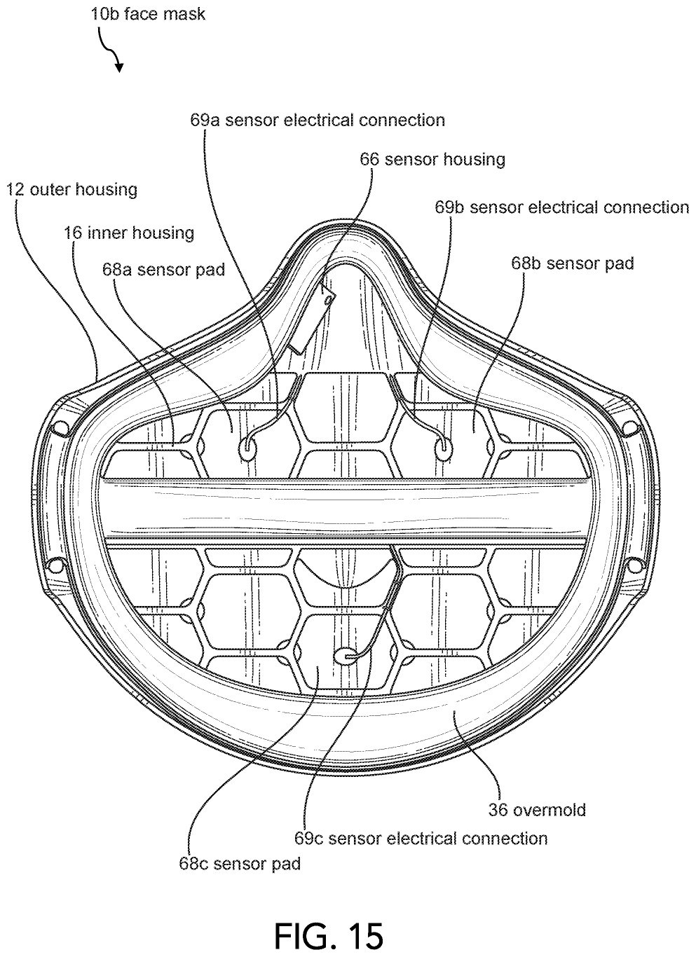

The face mask 10b may comprise a plurality of sensor units 64, wherein one sensor unit 64 is configured to detect the presence of a contaminant and one sensor unit 64 is configured to detect an air flow restriction. A determination that air flow through the replaceable filter 28 is less than a predetermined air flow restriction level may indicate that the replaceable filter 28 is at least one of approaching and has reached the end of the filter's 28 effective life. In many embodiments, the sensor unit 64 is at least partially located on an interior portion of the face mask 10b. The sensor unit 64 may be located on an exterior portion of the face mask 10b, including the outer housing 12. The sensor unit 64, and its operation, will be discussed in greater detail later in the disclosure. FIG. 15 illustrates a back view of the face mask 10b, according to some embodiments.

The face mask 10b may include the outer housing 12, as shown in FIG. 14, and may also include an inner housing 16 and an overmold 36. In many embodiments, the outer housing 12, inner housing 16, and overmold 36 are substantially the same as the outer housing 12, inner housing 16, and overmold 36 discussed with reference to the face mask 10a shown in FIGS. 1-13. It should be noted that, though not illustrated in the Figures, the face mask 10b may include a strap substantially similar to the strap 54 shown in FIGS. 1 and 11, which may couple to the mask 10b in a substantially similar manner as that illustrated in FIGS. 1 and 11.

The face mask 10b may also include a sensor housing 66 and a sensor pad 68a, 68b, and/or 68c, wherein the sensor housing 66 is at least one of electrically and communicatively coupled to the sensor pad 68a, 68b, and/or 68c. In some embodiments, the sensor housing 66 is coupled to the sensor pad 68a, 68b, and/or 68c via a sensor electrical connection 69a, 69b, and/or 69c. The sensor housing 66 may couple to the sensor pad 68a via the sensor electrical connection 69a, to the sensor pad 68b via the sensor electrical connection 69b, and to the sensor pad 68c via the sensor electrical connection 69c. In some embodiments, the face mask 10b includes more than three sensor pads and sensor electrical connections. The face mask 10b may comprise fewer than three sensor pads and sensor electrical connections. A single sensor electrical connection, for example the sensor electrical connection 69a, may be configured to couple multiple sensor pads, for example the sensor pad 68a and the sensor pad 68b, to the sensor housing 66.

In many embodiments, the sensor unit 64 included in FIG. 14 comprises the sensor housing 66 and the sensor pad 68a, 68b, and/or 68c. The sensor housing 66 may be located in an upper portion of the face mask 10b as demonstrated in FIG. 15. The upper portion may comprise a cavity configured to receive the nose 18 of a user 22. In some embodiments, the sensor housing 66 is located elsewhere on the face mask 10b. Each of the sensor pads 68a, 68b, and 68c may fit into a ventilation hole of the inner housing 16. In many embodiments, a ventilation hole may comprise a ventilation hole of the second plurality of ventilation holes 24 shown in FIGS. 3 and 6. The sensor pad 68a, 68b, and/or 68c may be configured to fit into a ventilation hole on an upper or lower chamber (32, 34 as shown in FIG. 6) of the inner housing 16. In some embodiments, the sensor pad comprises one, two, four, or more than four sensor pads. The face mask 10b may include no sensor pads as part of the sensor unit 64.

In some embodiments, the sensor pad comprises a first sensor pad 68a and a second sensor pad 68b. The first sensor pad 68a may be configured to detect a presence of a contaminant on the replaceable filter 28, and the second sensor pad 68b may be configured to detect whether air flow through the replaceable filter 28 is less than the predetermined air flow restriction level. As previously stated, in some embodiments, the LED 74 is configured to illuminate upon detection of at least one of the presence of a contaminant on the replaceable filter 28 and detection of whether air flow through the replaceable filter 28 is less than the predetermined air flow restriction level. The LED 74 may be configured to illuminate a first color upon detection of a contaminant, and to illuminate a second color upon detection of air flow restriction. In many embodiments, the second color is different from the first color. The second color may be substantially the same as the first color. At least one of the first and second colors may comprise a plurality of colors.

In some embodiments, the LED 74 is configured to illuminate in a first pattern upon detection of a contaminant and to illuminate in a second pattern upon detection of air flow restriction. The first and/or second pattern may comprise solid illumination, quick flashing, strobing, slow blinking, alternating fast and slow blinking, and the like. In some embodiments, the first and/or second pattern comprises emitting light in alternating colors. The alternating colors may include at least one of the first and second color, or any other color. In some embodiments, the first pattern is different from the second pattern. The first pattern may be substantially the same as the second pattern.

In some embodiments, the LED 74 comprises a red green blue (RGB) LED. The LED 74 may be configured to illuminate in a sequence to indicate the status of the replaceable filter 28. For example, if the filter 28 is in “good shape” (i.e., not contaminated, not breached, and/or high percent of effective life remaining), the LED 74 may illuminate a first color (e.g., green) at least some of the time. Once the filter 28 begins to wear down, the LED 74 may illuminate a second color (e.g., blue) at least some of the time. When the sensor unit 64 determines that the filter 28 is contaminated, breached, and/or has reached the end of its effective life, the LED 74 may illuminate a third color (e.g., red) at least some of the time. Illuminating “at least some of the time” may comprise constant illumination of the LED 74. Illuminating “at least some of the time” may comprise sporadic illumination (e.g., illumination for one minute every 10 minutes, illumination for 30 seconds every minute, etc.), blinking (e.g., alternating illumination every second or few seconds), and/or illumination upon movement of the mask 10b, such as when the mask 10b is removed or placed on a user 22. Each of the first color, the second color, and the third color may be any color, such as green, red, or blue.

The sensor unit 64 may comprise a number of different types of sensors, wherein each type of sensor operates in a different way. Disclosed herein are a few embodiments of sensors. It should be noted that a person having ordinary skill in the art would recognize that the sensor unit 64, and its operation, is not limited to the sensor examples disclosed herein and may extend to embodiments of future-developed sensors.

In some embodiments, the sensor unit 64 comprises a sensor traditionally used to detect bacteria levels in water. For example, the system may implement a bacteria detection sensor called the “bacometer” developed by The.Wave.Talk, which is an innovative sensor that can detect bacteria in real time without sampling. The system utilizes the principle of time reversal mirrors to detect bacteria within 0.1 second and transmit contamination status information to the mobile phone in real time. Therefore, the user can easily check the pollution degree of water in real time. Bacterial detection sensors, which are widely used, are expected to be applied to water purifiers and humidifiers. Such bacterial detection sensors may be adapted for use in a face mask, such as the mask 10b, to detect the presence of bacteria on the replaceable filter 28 rather than in water. A bacterial detection sensor may also be adapted for use in a face mask by placing the sensor on an interior portion of a filter 28, such that the sensor is exposed to saliva and/or condensation from a user 22 and may thereby analyze the saliva and/or condensation for bacteria levels.

Other microorganism biosensors may be adapted for use in the face mask 10b. For example, laboratory-on-a-chip (LoC) devices, or micro total analysis systems (μTAS), offer great advantages in terms of their material (e.g., reaction substrates) and time (i.e., rapid loading and analysis overhead) requirements. As a result, they are some of the most promising systems for the development of high throughput and automated biosensors. LoC systems featuring a number of microscale reaction chambers and channels are used to prepare samples and to deliver analytes (e.g., bacteria, DNA, etc.) toward miniaturized embedded sensing sites. The core part of a LoC system designed for microbial detection is a biosensor, which itself consists of a recognition element and a readout system. The recognition elements, e.g., antibodies, bacteriophages, antimicrobial peptides, and bacteriocins, are used to convert the biological phenomenon to a physical or chemical variation. Indeed, any microbial features, or the presence of any specific factor in a special microorganism, including genomic elements, antigenic properties, electromechanical properties, metabolic activities, and/or photographic indexes are potentially useful for the detection of microorganisms in a sample. The readout system or physicochemical transducers are used to sense, amplify, and measure the signals (mechanical, optical, electrochemical, and acoustic changes) obtained from the recognition element. A readout system can be implemented using microelectromechanical system (MEMS) technology or microelectronic technology.

Some embodiments of the sensor unit 64 include a sensor developed by a team of researchers from Empa, ETH Zurich, and Zurich University Hospital to specifically detect SARS-CoV-2, the coronavirus strain that causes the illness COVID-19. The sensor combines two different effects to detect the virus safely and reliably: an optical and a thermal effect. The sensor is based on gold nanoislands on a glass substrate. Artificially produced DNA receptors that match specific RNA sequences of the SARS-CoV-2 are grafted onto the nanoislands. The coronavirus is a so-called RNA virus: its genome does not consist of a DNA double strand as in living organisms, but of a single RNA strand. The receptors on the sensor are therefore the complementary sequences to the virus' unique RNA sequences, which can reliably identify the virus.

The technology the researchers use for detection is called LSPR, short for localized surface plasmon resonance. This is an optical phenomenon that occurs in metallic nanostructures: When excited, they modulate the incident light in a specific wavelength range and create a plasmonic near-field around the nanostructure. When molecules bind to the surface, the local refractive index within the excited plasmonic near-field changes. An optical sensor located on the back of the sensor can be used to measure this change and thus determine whether the sample contains the RNA strands in question.

However, it is important that only those RNA strands that match exactly the DNA receptor on the sensor are captured. This is where a second effect comes into play on the sensor: the plasmonic photothermal (PPT) effect. If the same nanostructure on the sensor is excited with a laser of a certain wavelength, it produces localized heat. As already mentioned, the genome of the virus consists of only a single strand of RNA. If this strand finds its complementary counterpart, the two combine to form a double strand—a process called hybridization. The counterpart—when a double strand splits into single strands—is called melting or denaturation. This happens at a certain temperature, the melting temperature. However, if the ambient temperature is much lower than the melting temperature, strands that are not complementary to each other can also connect. This could lead to false test results. If the ambient temperature is only slightly lower than the melting temperature, only complementary strands can join. And this is exactly the result of the increased ambient temperature, which is caused by the PPT effect.

In some embodiments, the sensor unit 64 comprises the FAST BioSensor developed by researchers at RTI International. The FAST BioSensor was developed as a low-cost bioaerosol early warning device able to detect airborne biological contaminants ranging in size from 0.15 microns to more than 5 microns. The FAST BioSensor may be communicatively coupled in an array that enables continuous, real-time monitoring of an area for the presence of a contaminant.

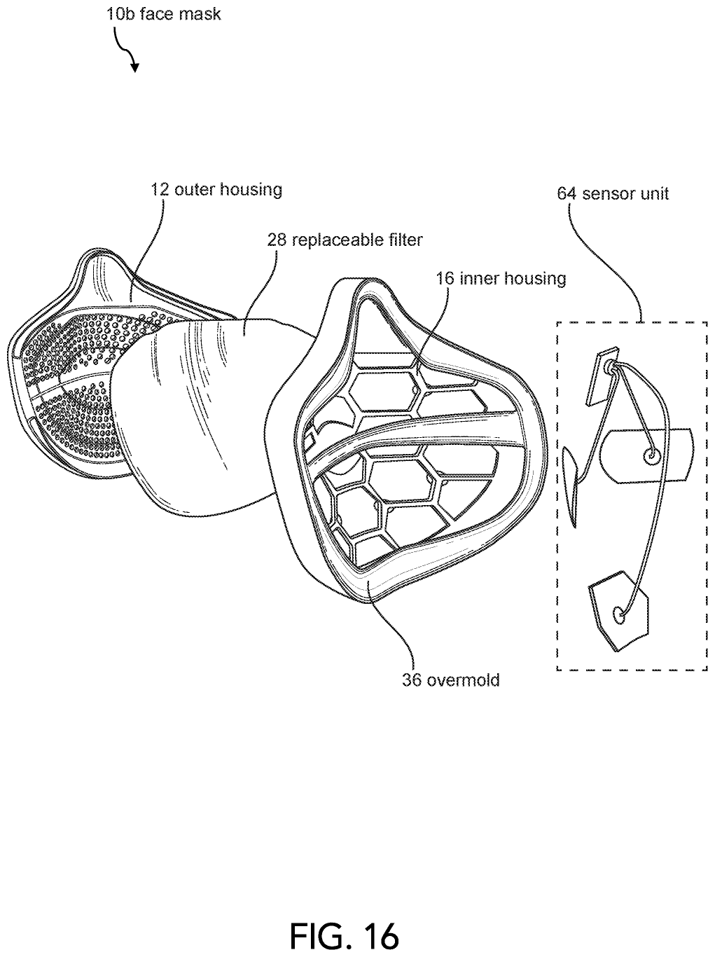

Turning now to FIG. 16, an exploded view of the face mask 10b is shown. As illustrated, the face mask 10b may comprise the outer housing 12, the replaceable filter 28, the inner housing 16, and the sensor unit 64. In some embodiments, the face mask 10b comprises additional components not included in the Figures. The face mask 10b may not include any one or multiple of the elements shown in FIG. 16. In many embodiments, the components of the face mask 10b are configured to couple together in a manner substantially similar to that described above with reference to FIGS. 9 and 10. Though not labeled in FIG. 16, the face mask 10b may include a channel lock similar to the channel lock included in some embodiments of the face mask 10a.

In some embodiments, and as indicated by FIG. 16, the sensor pad 68a, 68b, and/or 68c of the sensor unit 64 is configured to couple to an interior portion of the replaceable filter 28 via the inner housing 16. It should be noted that an “interior portion” of the replaceable filter 28 may be defined as the portion of the filter 28 located closer to a user's 22 face when the face mask 10b is worn, and an “exterior portion” may be defined as the portion located opposite the interior portion. Coupling to an interior portion of the replaceable filter 28 may enable the sensor pad 68a, 68b, and/or 68c to detect whether air flow through the filter 28 is less than a predetermined restriction level. Coupling to an interior portion may also enable the sensor pad 68a, 68b, and/or 68c to detect a breach in the filter 28.

In some embodiments, the sensor pad 68a, 68b, and/or 68c is located on an exterior portion of the replaceable filter 28. Coupling to an exterior portion of the filter 28 may enable the sensor pad 68a, 68b, and/or 68c to detect the presence of a contaminant on the filter 28. A contaminant may be defined as any bacteria, virus, fungus, microbe, allergen, pollutant, heavy metal, toxic gas, or any other potentially harmful substance or combination therein. In some embodiments, a sensor pad 68a, 68b, and/or 68c is located on the interior portion and a sensor pad 68a, 68b, and/or 68c is located on the exterior portion of the replaceable filter 28, thereby enabling the sensor unit 64 to detect both the presence of a contaminant and air flow restriction of the mask 10b. The replaceable filter 28 may comprise three layers. In some embodiments, the filter 28 comprises four layers, as shown in FIG. 12. The filter 28 may include any number of layers, including one layer, two layers, and more than four layers.

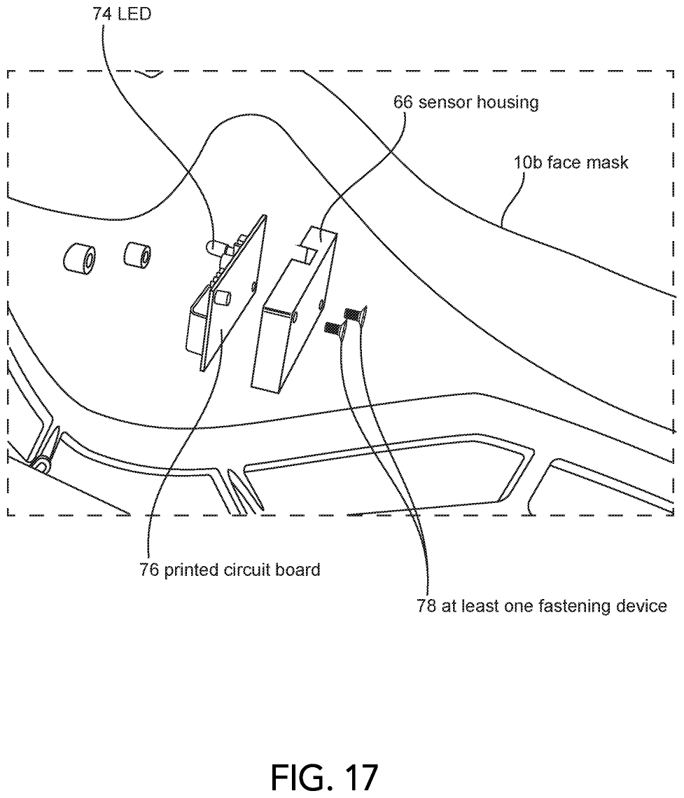

FIG. 17 shows a zoomed-in view of the sensor housing 66 and some associated components. In many embodiments, the sensor housing 66 includes the LED 74, a printed circuit board 76, and at least one fastening device 78. The at least one fastening device 78 may be configured to mechanically couple the sensor housing 66 to the face mask 10b. The at least one fastening device 78 may include at least one screw, at least one adhesive substance, at least one magnet, at least one snap, or any other suitable device. The at least one fastening device 78 may be configured to couple the sensor housing 66 to the face mask 10b via the protrusions illustrated to the left of the printed circuit board 76. As previously stated, the LED 74 may be configured to protrude through the inner housing 16 of the mask 10b to an interior portion of the outer housing 12, such that the LED 74 is visible through an opening on an exterior portion of the outer housing 12. In some embodiments, the LED 74 protrudes through the opening on the exterior portion of the outer housing 12, such that it is raised from the exterior portion.

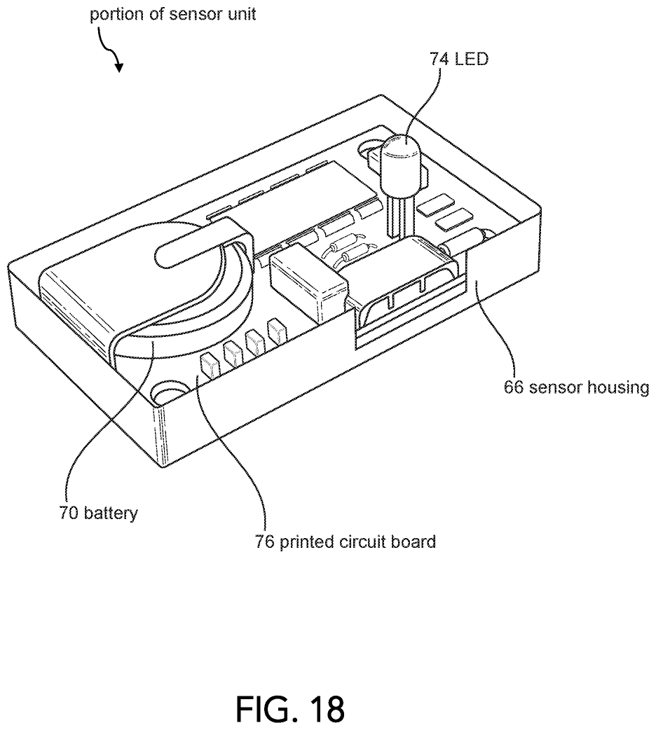

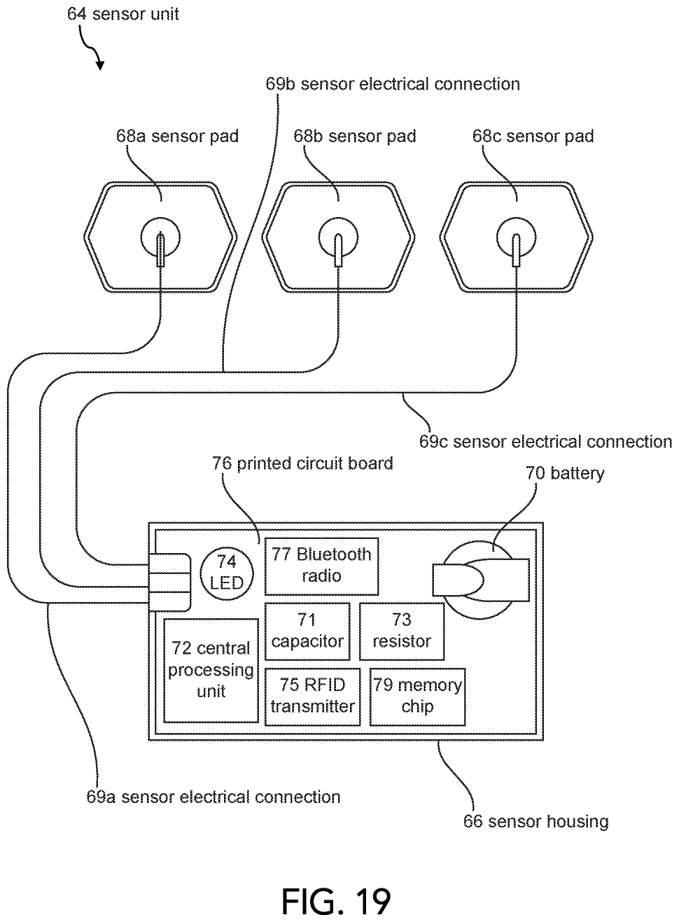

FIG. 18 shows another view of a portion of the sensor unit, including the sensor housing 66. In many embodiments, the portion of the sensor unit includes a battery 70, the LED 74, and the printed circuit board 76 coupled to the sensor housing 66. The LED 74 may be coupled to the printed circuit board 76. In some embodiments, the battery 70 is also coupled to the printed circuit board 76. The printed circuit board 76 may also include other elements not included in FIG. 18, such as those illustrated in FIG. 19. As shown in FIG. 19, the printed circuit board 76 may also include a central processing unit 72, a capacitor 71, a resistor 73, a RFID transmitter 75, a Bluetooth radio 77, and a memory chip 79. In some embodiments, the printed circuit board 76 includes components not shown in the Figures. FIG. 19 also illustrates the electrical coupling between the sensor housing 66 and the sensor pad 68a, 68b, and/or 68c. In some embodiments, and as demonstrated in FIG. 19, the sensor pad 68a, 68b, and/or 68c is coupled to the sensor housing 66 via a sensor electrical connection 69a, 69b, and/or 69c. Each sensor pad 68a, 68b, and 68c may be coupled to the sensor housing 66 via a sensor electrical connection 69a, 69b, and 69c comprising a single wire, as demonstrated in FIG. 19. In some embodiments, each sensor pad 68a, 68b, and 68c is coupled to the sensor housing 66 via a sensor electrical connection 69a, 69b, and 69c comprising a plurality of wires. The sensor pad 68a, 68b, and/or 68c may be coupled to the sensor housing 66 via a wireless connection.

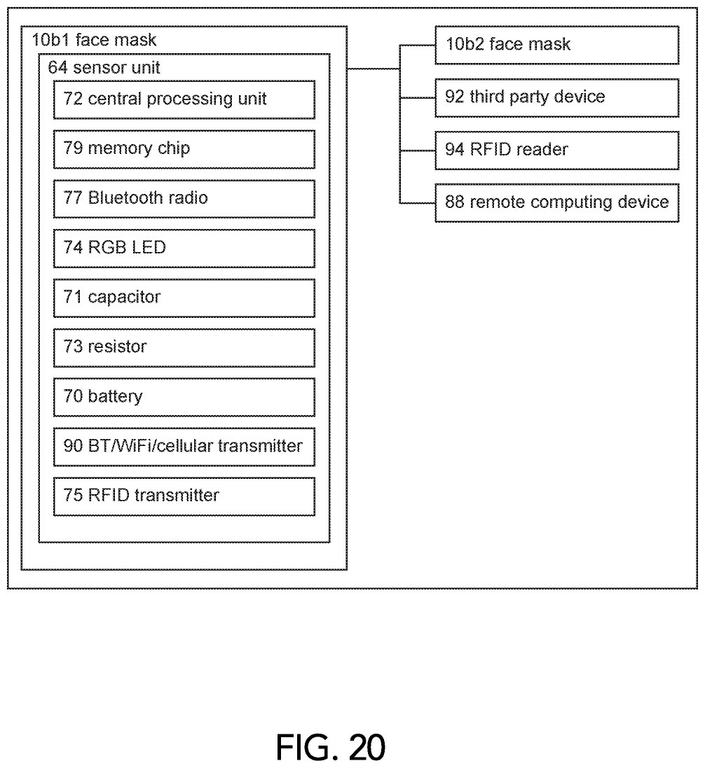

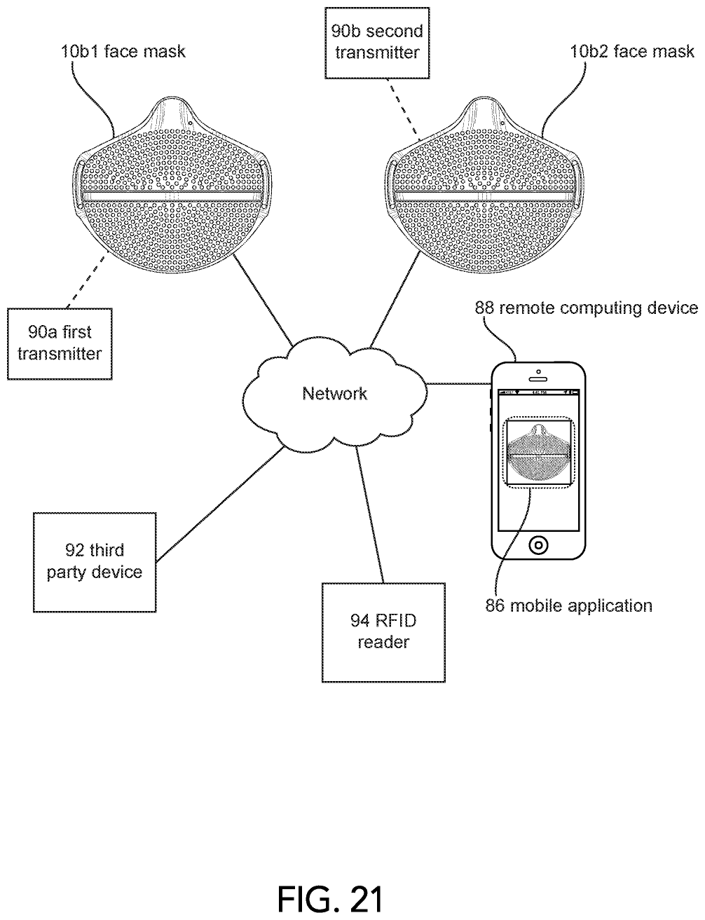

In some embodiments, the central processing unit 72 is electrically coupled to the battery 70, and is capable of detecting at least one of the presence of a contaminant on the replaceable filter 28 and whether the air flow through the filter 28 is less than a predetermined air flow restriction level. The central processing unit 72 may be capable of determining the identity of a contaminant detected on the replaceable filter 28. The central processing unit 72 may also be capable of determining a percent of effective life that remains for the filter 28. In many embodiments, the central processing unit 72 is configured to communicatively couple to a device (e.g., remote computing device 88, third party device 92, RFID reader 94, and the like discussed with reference to FIGS. 20 and 21) in order to share status data of the filter 28, including but not limited to, the presence and/or identity of a contaminant and the percent of filter life remaining before the filter 28 should be replaced.

In many embodiments, the face mask 10b comprises a first face mask 10b1 and a second face mask 10b2, wherein the first face mask 10b1 and the second face mask 10b2 are communicatively coupled to one another, as well as to other devices. FIG. 20 depicts the face masks 10b1 and 10b2, as well as some examples of other communicatively coupled devices, according to some embodiments. As previously discussed, the face mask 10b1 may include a sensor unit 64 comprising at least one of a central processing unit 72, a memory chip 79, a Bluetooth radio 77, an RGB LED 74, a capacitor 71, a resistor 73, and a battery 70. In some embodiments, and as will be discussed further with reference to FIG. 21, the face mask 10b1 also includes at least one of a Bluetooth/WiFi/cellular transmitter 90 and an RFID transmitter 75. Though not indicated as such in FIG. 20, the face mask 10b2 may also include any or all of the listed components included in the face mask 10b1. At least one of the face mask 10b1 and 10b2 may comprise additional components not disclosed here.

FIG. 20 shows that, in some embodiments, the face mask 10b1 is communicatively coupled to the face mask 10b2, a third party device 92, an RFID reader 94, and a remote computing device 88. The face mask 10b2 may also be communicatively coupled to the third party device 92, the RFID reader 94, and the remote computing device 88. In some embodiments, the face mask 10b1 and the face mask 10b2 are communicatively coupled to the same third party device 92, the same RFID reader 94, and the same remote computing device 88. The face mask 10b1 and 10b2 may be communicatively coupled to different units of at least one of a third party device 92, a RFID reader 94, and a remote computing device 88. At least one of the face mask 10b1 and the face mask 10b2 may be communicatively coupled to multiple units of at least one of a third party device 92, a RFID reader 94, and a remote computing device 88. In some embodiments, at least one of the face mask 10b1 and the face mask 10b2 is communicatively coupled to the Cloud.

Referring now to FIG. 21, in many embodiments, the face mask 10b1 comprises a first transmitter 90a and the face mask 10b2 comprises a second transmitter 90b. At least one of the first transmitter 90a and the second transmitter 90b may be capable of at least one of Bluetooth, WiFi, and cellular communication, as indicated in FIG. 20. In some embodiments, the face mask 10b1 is communicatively coupled to the face mask 10b2 via at least one of the first transmitter 90a and the second transmitter 90b. The face mask 10b1 may be configured to communicate with the face mask 10b2 through the first transmitter 90a communicating with the second transmitter 90b via at least one of Bluetooth, WiFi, and cellular network communication. The first transmitter 90a may communicate with the second transmitter 90b through any other form of communication not listed here. In many embodiments, the first transmitter 90a is configured to share data regarding the replaceable filter 28 of the face mask 10b1 with the second transmitter 90b, and the second transmitter 90b is configured to share data regarding a replaceable filter 28 of the face mask 10b2 with the first transmitter 90a. The data regarding the replaceable filter 28 may include information related to the projected remaining effective lifetime of the filter 28, the presence of a contaminant on the filter 28, whether the filter 28 has been breached, an air flow restriction level of the filter 28, and any other suitable data concerning the filter 28. It should be noted that at least one of the first transmitter 90a and the second transmitter 90b may function as a transceiver.

In some embodiments, the sensor unit 64 of at least one of the face mask 10b1 and the face mask 10b2 is communicatively coupled to a mobile application 86 on the remote computing device 88. At least one of the first transmitter 90a and the second transmitter 90b may be configured to receive data from the sensor unit 64 regarding the filter 28, and relay that data to the mobile application 86 via a network, as depicted in FIG. 21. The network may comprise any Bluetooth, WiFi, cellular, radio, or other suitable network capable of communication. By displaying the data on the mobile application 86, a user 22 of the face mask 10b1 and/or face mask 10b2 may be able to monitor a status of the replaceable filter 28, thereby making it easier for the user 22 to anticipate when the filter 28 needs to be replaced. This in turn may improve the quality of the user experience as well as the overall effectiveness of wearing the face mask 10b1 and/or 10b2 by enabling optimum replacement of the filter 28.

In some embodiments, the sensor unit 64 of at least one of the face mask 10b1 and the face mask 10b2 is communicatively coupled to a third party device 92. The third party device 92 may comprise a RFID reader 94, among other suitable devices. The sensor unit 64 of at least one of the face mask 10b1 and the face mask 10b2 may be communicatively coupled to the third party device 92 via at least one of the first transmitter 90a and the second transmitter 90b. As previously discussed, the first transmitter 90a and/or the second transmitter 90b may communicate with each other, a remote computing device 88, and a third party device 92 via at least one of Bluetooth, WiFi, and cellular communication.

In an embodiment where the third party device 92 comprises a RFID reader 94, the RFID reader 94 may be configured to obtain data from at least one of the first transmitter 90a and the second transmitter 90b and determine, from the data, a status of at least one of the face mask 10b1 and the face mask 10b2. For example, the RFID reader 94 may be located in a public area with heavy foot traffic, such as an airport, mall, hospital, school, stadium/arena, or the like. The RFID reader 94 may be able to communicate with one or a plurality of face masks 10b worn by various users 22 located in the public area in order to determine a status of a user's 22 face mask 10b. If the face mask 10b is indicated as having a predetermined status (e.g., contaminated, breached, past effective filter life, etc.), the RFID reader 94 may be configured to communicate with a transmitter 90 of the impacted mask 10b, which in turn can send an alert to a remote computing device 88 belonging to the impacted user 22. As such, the RFID reader 94 may function to monitor large, heavily populated areas.

In addition to the detection of a contaminant and/or an air flow restriction of the replaceable filter 28, the sensor unit 64 may be configured to detect indicators (e.g., biomarkers, volatile organic compounds, and the like) of disease. For example, the sensor unit 64 may comprise an organic semiconductor capable of gas sensing such that the sensor unit 64 is configured to detect disease markers present in the breath of the user 22. In some embodiments, the sensor unit 64 is configured to detect elevated levels of ammonia in a user's breath, which can be an indicator of kidney disease and/or failure. Upon detection of elevated ammonia levels, the sensor unit 64 may be configured to send an alert to the remote computing device 88 of the user 22 encouraging the user 22 to seek medical attention. Gas sensing may be enabled by using ammonia-sensitive material in reactive sites of the sensor unit 64, especially in the sensor pad 68a, 68b, and/or 68c. In some embodiments, the sensor pad 68a, 68b, and/or 68c comprises a plurality of pores configured to expose the reactive sites such that the breath of the user 22 comes into contact with the reactive sites. The reactive sites may define a sensitivity as acute as one part per billion. The reactive sites may be comprised of a material sensitive to other compounds, in addition to or instead of ammonia, such that the reactive sites may enable the detection of elevated levels of other, or additional, compounds. In some embodiments, the reactive sites are sensitive to a combination of compounds, elevated levels of which indicate disease.

As previously mentioned, the sensor unit 64 may be configured to detect the presence of volatile organic compounds (VOCs) in the exhaled breath of a user 22. VOCs may be defined as organic compounds that have high vapor pressure at ambient conditions. The presence of VOCs may indicate any number of respiratory diseases, including but not limited to chronic obstructive pulmonary disease (COPD), asthma, lung cancer, pulmonary arterial hypertension, tuberculosis, cystic fibrosis, obstructive sleep apnea syndrome, and pneumoconiosis. In some embodiments, the sensor unit 64 comprises an array of cross-reactive sensors, where each sensor in the array is sensitive to a range of VOCs. The sensor unit 64 may also be capable of pattern recognition, such that each VOC in the detected range of VOCs is identifiable and the concentration of each VOC can be determined.

VOC sensitive sensors may include different types of sensors, including but not limited to chemiresistors, acoustic sensors, and colorimetric sensors. The sensor unit 64 may comprise any one or combination of chemiresistors, acoustic sensors, and colorimetric sensors. A chemiresistor may be defined as a sensor that alters electrical resistivity as a result of sorption of VOCs. An acoustic sensor may be defined as a sensor that detects changes in the velocity and amplitude of acoustic waves through and/or on the surface of the sensor's coating material, which occur as a result of sorption of VOCs. A colorimetric sensor may be defined as a sensor that contains chemoresponsive dyes that chemically react and change color in response to exposure to VOCs. A person having ordinary skill in the art will understand that the definitions of each type of sensor listed may extend beyond the included explanations.

The table below includes some examples of biomarkers and their associated disease(s). The sensor unit 64 may be configured to identify and analyze and and/or all of the listed biomarkers. The sensor unit 64 may also be configured to identify and analyze biomarkers not listed below. It should be noted that the listed biomarkers may indicate other diseases in addition to those listed in the table.

| Biomarker | Major Disease |
|---|---|
| Ammonia | Renal failure, liver dysfunction, cirrhosis of liver, |
| | peptic ulcer, halitosis |
| Nitric Oxide | Asthma, COPD, lung cancer, animal allergy |
| Hydrogen | Asthma, airway inflammation, oral malodor, dental |
| Sulfide | disease |
| Acetone | Diabetes |
| Isoprene | Diabetes, hypercholesterolemia |
| Methane, Ethane, | Intestine and colon related disease, breast cancer, |
| Pentane | liver disease, asthma |
| Aldehydes | Cancers, Alzheimer's disease, Parkinson's disease, |
| | Wernicke's encephalopathy, Amyotrophic Lateral |
| | Sclerosis (ALS) |

In some embodiments, the sensor unit 64 is coupled to the face mask 10b at the point of manufacture. The user 22 of the face mask 10b may couple the sensor unit 64 to the face mask 10b. The user 22 may be required to change the battery 70 of the sensor unit 64 at regular intervals, such as once a month, once a quarter, bi-annually, annually, and any other time interval. The user 22 may gain access to the battery 70 by decoupling the sensor housing 66 from the face mask 10b via the at least one fastening device 78. In some embodiments, changing the battery 70 does not require removal of the sensor pad 68a, 68b, and/or 68c. Changing the battery 70 may require movement and/or removal of the sensor pad 68a, 68b, and/or 68c. The battery 70 may comprise any number of suitable battery types, and is not limited to a round battery as illustrated in FIGS. 18 and 19.

In many embodiments, the face mask 10b is comprised of substantially the same material as the face mask 10a, namely a material infused with silver nanoparticles. The face mask 10b may also be washable, like the face mask 10a. In some embodiments, the sensor unit 64 is removed prior to washing the mask 10b. The sensor unit 64 may remain coupled to the mask 10b during washing. In some embodiments, at least one component of the sensor unit 64 is removed prior to washing the mask 10b. For example, the sensor pad 68a, 68b, and/or 68c may be removed prior to washing the mask 10b. In some embodiments, the sensor housing 66 is removed prior to washing the mask 10b. At least one of the sensor housing 66 (including its associated elements shown in FIGS. 17-19), the sensor pad 68a, 68b, and/or 68c, and the sensor electrical connection 69a, 69b, and/or 69c may be comprised of a substantially waterproof material.

### Sport Embodiment

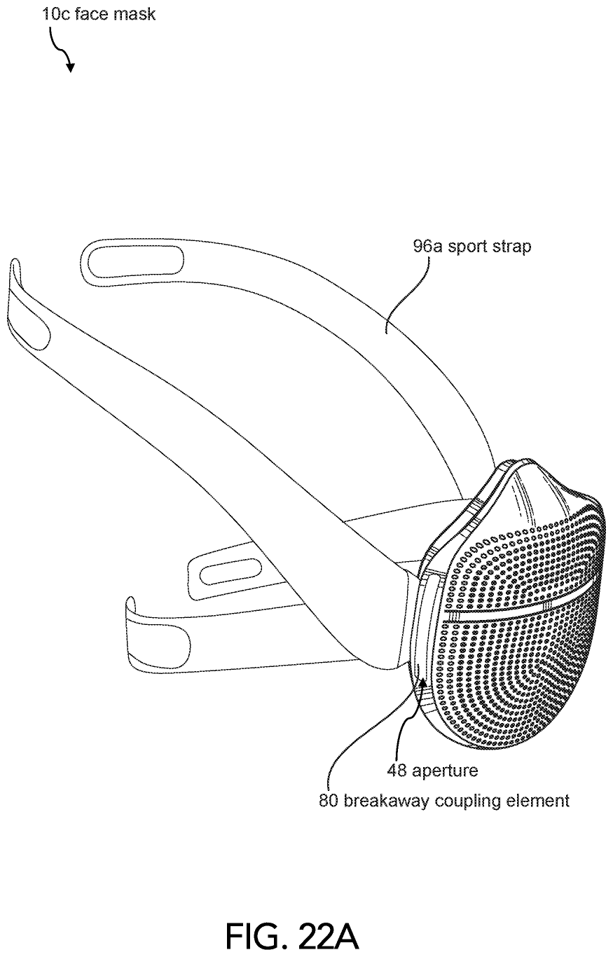

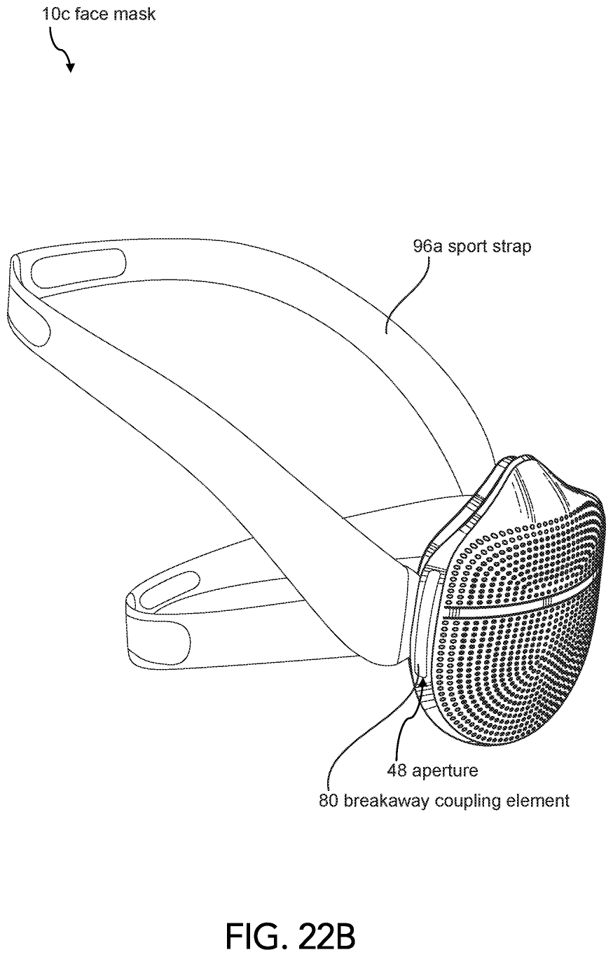

Referring now to FIG. 22A, an embodiment of a face mask 10c is shown. In many embodiments, the face mask 10c is considered a “sport mask.” The mask 10c may include a sport strap 96a (shown in an open configuration), an aperture 48, and a breakaway coupling element 80. The sport strap 96a may serve a similar function as the strap 54 discussed with reference to the face mask 10, but may be specifically designed for use while a user 22 is engaged in exercise or athletic competition. In some embodiments, the sport strap 96a comprises a moisture-wicking material, such as neoprene. The sport strap 96a may comprise a greater width than the strap 54. In some embodiments, a greater width enables the sport strap 96a to fit more snugly and remain in position, even during vigorous physical activity. The sport strap 96a may comprise an adjustable fit to accommodate a range of head sizes of different users 22. In some embodiments, the sport strap 96a includes hook-and-loop fastener, as represented by the rounded rectangles located near the open ends of the strap 96a. The sport strap 96a may include any suitable fastening method, including, but not limited to, buttons, snaps, and a strap adjuster similar to that commonly seen on a baseball hat. FIG. 22B shows the face mask 10c with the sport strap 96a in a closed configuration.

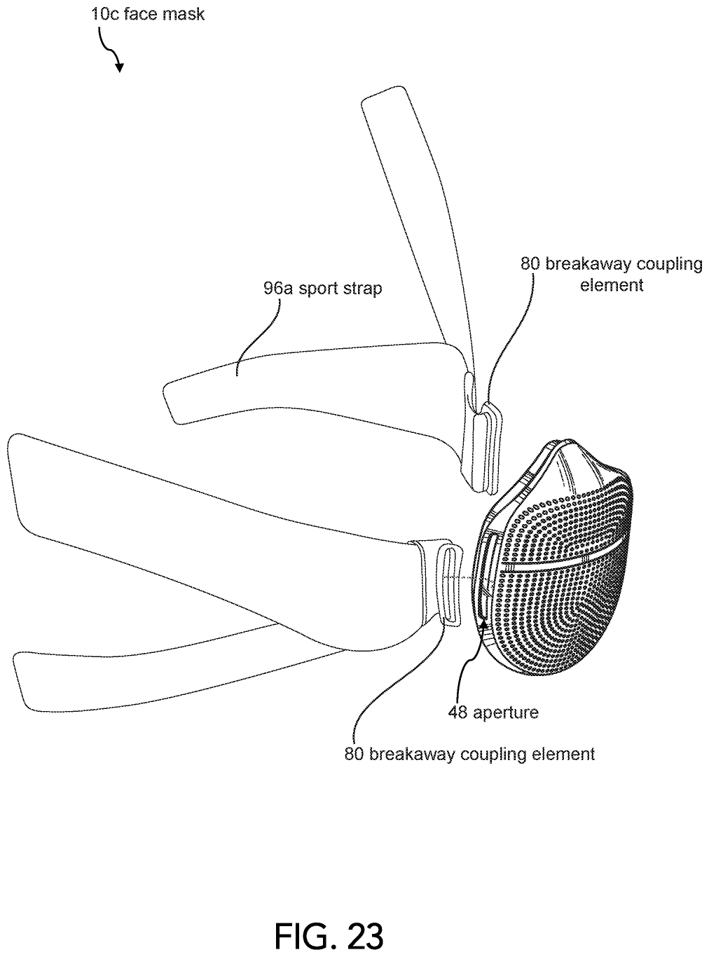

The aperture 48 of the face mask 10c may be substantially similar to the aperture 48 discussed with reference to the face mask 10. In many embodiments, the sport strap 96a includes a breakaway coupling element 80 configured to detachably couple to the aperture 48, thereby coupling the sport strap 96a to the rest of the face mask 10c. The breakaway coupling element 80 may couple to the aperture 48 via a friction fit. When a force of friction exceeds a predetermined level, such as when the face mask 10c is being forcibly pulled from a user's 22 face, the breakaway coupling element 80 may be configured to detach from the aperture 48, as illustrated in FIG. 23.

For example, if a user 22 is playing a physical, high-contact sport such as rugby, an opponent player may grab at the user's 22 mask 10c. In such an event, rather than allowing the user to be pulled to the ground via the mask 10c, the breakaway coupling element 80 may detach from the aperture 48, thereby freeing the user 22 from the mask 10c. The breakaway function of the mask 10c may help prevent injury to a user 22, both by preventing the user 22 from being pulled to the ground via the mask 10c, and also by reducing the possibility that the mask 10c could be pulled and released to “snap back” onto the face of the user 22 and potentially cause injury to the user's 22 face, including nose, mouth, and/or eye injury. In some embodiments, and as shown in FIG. 23, the sport strap 96a comprises two breakaway coupling elements 80. The breakaway function of the mask 10c may result in the decoupling of one or both breakaway coupling elements 80 from the aperture(s) 48.

FIG. 23 also includes a dashed arrow illustrating the path of coupling between the aperture 48 and the breakaway coupling element 80. In many embodiments, the breakaway coupling element 80 couples to a front surface of the aperture 48 by moving through a back surface of the aperture 48 and hooking onto the aperture 48. As used here, the “front surface” of the aperture 48 should be understood to mean the surface adjacent the front of the face mask 10c (the exterior surface of the outer housing 12). The “back surface” of the aperture 48 should be understood to mean the surface located opposite the front surface, adjacent the inner housing 16 and located closest to the face of the user 22 when the mask 10c is worn.

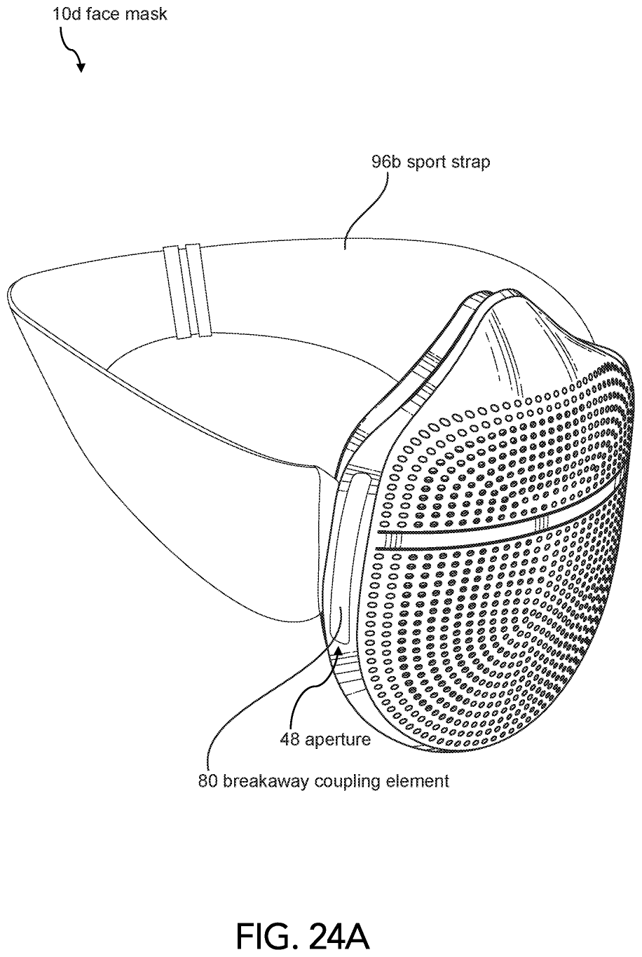

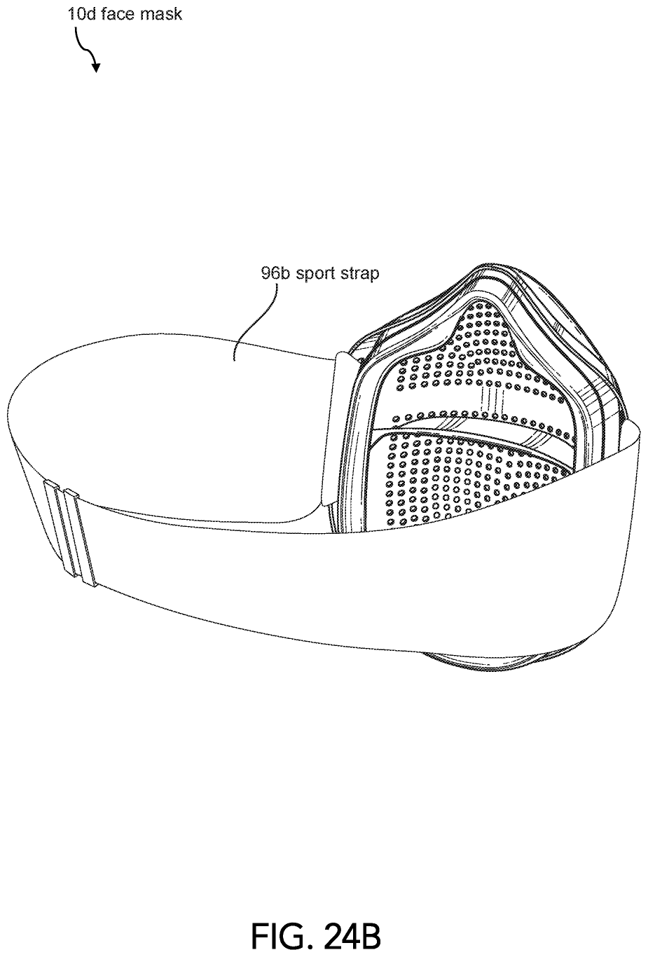

FIGS. 24A and 24B illustrate a face mask 10d. In many embodiments, the face mask 10d is another sport mask, similar to the face mask 10c. As shown, the mask 10d comprises a sport strap 96b, which comprises a single strap rather than a double strap, like the sport strap 96a. Both sport straps 96a, 96b may provide comfortable and snug fits for the user 22, with a moisture-wicking material for additional comfort. The use of the double sport strap 96a or the single sport strap 96b may simply be a matter of personal choice for each user 22.

It should be noted that in many embodiments, each of the face masks 10a, 10b, 10c, and 10d comprise substantially the same outer housing 12, inner housing 16, and overmold 36 comprised of substantially the same material(s). The replaceable filter 28 may comprise three or four layers. In some embodiments, the sport embodiments (i.e., the face masks 10c and 10d) comprise larger outer housings 12, inner housings 16, overmolds 36, apertures 48, and/or filters 28. Each of the listed components may be at least one of taller and wider than the corresponding components in the masks 10a and 10b. The lower chamber of the face masks 10c, 10d may be substantially taller than the upper chamber. This may enable a user 22 to open their mouth 20 more widely to accommodate heavy breathing, shouting, or other activities not generally undertaken when wearing the non-sport mask embodiments 10a, 10b. In some embodiments, at least one of the sports mask 10c, 10d comprises the sensor unit 64 discussed with reference to the face mask 10b.

### Interpretation

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section.

Some of the devices, systems, embodiments, and processes use computers. Each of the routines, processes, methods, and algorithms described in the preceding sections may be embodied in, and fully or partially automated by, code modules executed by one or more computers, computer processors, or machines configured to execute computer instructions. The code modules may be stored on any type of non-transitory computer-readable storage medium or tangible computer storage device, such as hard drives, solid state memory, flash memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments can include A, B, and C. The term “and/or” is used to avoid unnecessary redundancy.

The term “substantially” is used to mean “completely”, “nearly completely”, “exactly”, or “nearly exactly.” For example, the disclosure includes “in some embodiments, substantially an entire surface of the outer housing 12 includes the first plurality of ventilation holes 14.” In this context, the term “substantially” indicates that completely/exactly or nearly completely/exactly the entire surface of the outer housing includes the first plurality of ventilation holes.

The term “about” is used to mean “approximately.” For example, the disclosure includes “In some embodiments, a child-size face mask 10 is configured to fit an average-sized child up to about 10 years old.” In this context, the child-size mask is configured to fit a child up to approximately 10 years old. A child between 8 and 12 years old may fall into the range of “about 10 years old” in the context of this disclosure.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

1. A system of protective face masks including a protective face mask, comprising:
an outer housing including a first plurality of ventilation holes;
an inner housing detachably coupled to the outer housing, the inner housing configured to cover a nose and a mouth of a user, the inner housing including a second plurality of ventilation holes, wherein a space between the inner housing and the outer housing is configured to receive a replaceable filter; and
a sensor unit coupled to at least one of the inner housing and the outer housing, the sensor unit comprising a sensor housing and at least one sensor pad configured to detect a presence of a contaminant on the replaceable filter, wherein the sensor housing is coupled to the at least one sensor pad via at least one sensor electrical connection and wherein the sensor housing is coupled to an inner portion of the outer housing and the at least one sensor pad is coupled to the inner housing.

2. The system of protective face masks of claim 1, wherein the at least one sensor pad is configured to detect whether air flow through the replaceable filter is less than a predetermined air flow restriction level.

3. The system of protective face masks of claim 2, wherein the sensor housing is at least one of electrically and communicatively coupled to the at least one sensor pad via the at least one sensor electrical connection.

4. The system of protective face masks of claim 3, further comprising:
a battery coupled to the sensor unit;
a central processing unit coupled to the sensor unit and electrically coupled to the battery, wherein the central processing unit is capable of detecting at least one of the presence of the contaminant on the replaceable filter and whether the air flow through the replaceable filter is less than the predetermined air flow restriction level; and
a light-emitting diode (LED) coupled to the sensor unit and electrically coupled to the battery.

5. The system of protective face masks of claim 4, wherein the LED is configured to protrude through the inner housing to an interior portion of the outer housing, such that the LED is visible through an opening on an exterior portion of the outer housing.

6. The system of protective face masks of claim 5, wherein the LED is configured to illuminate in response to detecting the presence of the contaminant on the replaceable filter.

7. The system of protective face masks of claim 5, wherein the LED is configured to illuminate in response to detecting whether the air flow through the replaceable filter is less than the predetermined air flow restriction level.

8. The system of protective face masks of claim 3, wherein the at least one sensor pad is configured to couple to at least one ventilation hole of the second plurality of ventilation holes.

9. The system of protective face masks of claim 5, wherein the LED is configured to emit light in at least one of a plurality of colors and a plurality of patterns.

10. The system of protective face masks of claim 9, wherein the LED is configured to emit light in at least one of a first color and a first pattern upon detection of the presence of the contaminant on the replaceable filter, and is configured to emit light in at least one of a second color and a second pattern upon detection of whether air flow through the replaceable filter is less than the predetermined air flow restriction level.

11. The system of protective face masks of claim 3, wherein the at least one sensor pad comprises a first sensor pad and a second sensor pad, wherein the first sensor pad is configured to detect the presence of the contaminant on the replaceable filter and the second sensor pad is configured to detect whether air flow through the replaceable filter is less than the predetermined air flow restriction level.

12. The system of protective face masks of claim 11, wherein the first sensor pad is located on an exterior surface of the replaceable filter and the second sensor pad is located on an interior surface of the replaceable filter.

13. The system of protective face masks of claim 2, wherein the sensor unit is communicatively coupled to a mobile application on a remote computing device and is configured to share data about the replaceable filter with the mobile application.

14. The system of protective face masks of claim 3, wherein the sensor unit further comprises a transmitter capable of at least one of short-range wireless communication and cellular communication.

15. The system of protective face masks of claim 14, wherein the protective face mask of claim 14 comprises a first protective face mask and the transmitter of claim 14 comprises a first transmitter, further comprising a second protective face mask including a second transmitter capable of at least one of short-range wireless communication and cellular communication.

16. The system of protective face masks of claim 15, wherein the first protective face mask is configured to communicate with the second protective face mask via the first transmitter communicating with the second transmitter via at least one of short-range wireless communication and cellular communication.

17. The system of protective face masks of claim 16, wherein the first transmitter is configured to share data regarding the replaceable filter with the second transmitter, and the second transmitter is configured to share data regarding a replaceable filter of the second protective face mask with the first transmitter.

18. The system of protective face masks of claim 15, further comprising a third party device configured to communicate with at least one of the first transmitter and the second transmitter via at least one of Bluetooth, WiFi, and cellular communication.

19. The system of protective face masks of claim 18, wherein the third party device comprises a radio frequency identification (RFID) reader configured to obtain data from at least one of the first transmitter and the second transmitter and determine, from the data, a status of at least one of the first protective face mask and the second protective face mask.

20. The system of protective face masks of claim 1, wherein the replaceable filter comprises three layers.
